(19) United States
(12) Patent Application Publication
(10) Pub. No.: US 2025/0278775 A1
(43) Pub. Date: Sep. 4, 2025

(54) Dynamic Data Object Distribution Based on Historical Performance

(71) Applicant: Uber Technologies, Inc., San Francisco, CA (US)

(72) Inventors: Christopher Blinn, Mountain View, CA (US); Pushkar Ravindra Joshi, Sunnyvale, CA (US); Nolberto Castellanos Rodríguez, Medellín, Antioquia (CO); Reuben Matthew Shorser, San Francisco, CA (US); Maxwell Dean Stein, Jersey City, NJ (US); Wei Xiong, Bothell, WA (US)

(21) Appl. No.: 18/651,077

(22) Filed: Apr. 30, 2024

Related U.S. Application Data
(60) Provisional application No. 63/560,260, filed on Mar. 1, 2024.

(51) Int. Cl. G06Q 30/0601

(52) U.S. Cl. CPC G06Q 30/0633

(57) ABSTRACT

Systems and method for dynamic data object distribution based on historical performance. The method includes accessing a centralized data structure with a number of order requests. Computing a shopping list including data objects for items and characteristic data for each item. Accessing data indicative of selection of the first shopping list by a first device, updating the order status of the first shopping list. Accessing data indicative of selection of the first shopping list by a second device. Computing a first subset of items and second subset of items for each respective computing device based on (i) features associated with the first computing device, (ii) features associated with the second computing device, and (iii) the characteristic data of each respective item of a plurality of items. Transmitting data to cause an interactive user interface of the first computing device to display the first subset of items.

### FIELD

The present disclosure generally relates to dynamic data object distribution based on historical performance associated with user profiles. More particularly, data from mobile client devices can be monitored in real-time to update data structures to intelligently split data objects associated with items in a list to optimize performance metrics moving forward.

### BACKGROUND

Food delivery services allow a user to request a service that can be performed by a vehicle or courier. For instance, a user can request, through a delivery service application, a delivery service having a pick-up location, a drop-off location, and items for delivery. A courier and/or shopper can be assigned to perform the delivery service for the user. This can include selecting items from a pick-up location and transporting the items to a transition point and/or drop-off location.

### SUMMARY

Aspects and advantages of embodiments of the present disclosure will be set forth in part in the following description, or can be learned from the description, or can be learned through practice of the embodiments.

One aspect of the present disclosure is directed to a computing system. The computing system includes one or more processors and one or more tangible, non-transitory, computer readable media that store instructions that are executable by the one or more processors to cause the computing system to perform operations. The operations include accessing data including a centralized data structure including a plurality of order requests, wherein each order request of a centralized list of order requests includes a plurality of data objects, each data object being indicative of an item. The operations include computing, based on a first order request of the centralized list of order requests and merchant location data, a shopping list including: (i) the plurality of data objects for items to be retrieved for the first order and (ii) characteristic data for each respective item. The operations include storing the computed shopping list and a plurality of other additional shopping lists in a shopping list data store, the shopping list data store accessible to a plurality of shopper computing devices. The operations include accessing data indicative of selection of the first shopping list by a first computing device of the plurality of shopper computing devices. The operations include automatically updating, based on accessing the data indicative of the selection of the first shopping list, the shopping list data store to include order status data. The operations include accessing data indicative of selection of the first shopping list by a second computing device of the plurality of shopper computing devices. The operations include based on accessing data indicative of selection of the first shopping list by the first computing device and the second computing device, computing a first subset of items for the first computing device and a second subset of items for the second computing device based on (i) features associated with the first computing device, (ii) features associated with the second computing device, and (iii) the characteristic data of each respective item of a plurality of items. The operations include transmitting data including instructions, that, when executed by the first computing device, cause an interactive user interface of the first computing device to provide the first subset of items for display via the interactive user interface of the first computing device.

Another Example aspect of the present disclosure is directed to a computer-implemented method. The method includes accessing data including a centralized data structure including a plurality of order requests, wherein each order request of a centralized list of order requests includes a plurality of data objects, each data object being indicative of an item. The method includes computing, based on a first order request of the centralized list of order requests and merchant location data, a shopping list including: (i) the plurality of data objects for items to be retrieved for the first order and (ii) characteristic data for each respective item. The method includes storing the computed shopping list and a plurality of other additional shopping lists in a shopping list data store, the shopping list data store accessible to a plurality of shopper computing devices. The method includes accessing data indicative of selection of the first shopping list by a first computing device of the plurality of shopper computing devices. The method includes automatically updating, based on accessing the data indicative of the selection of the first shopping list, the shopping list data store to include order status data. The method includes accessing data indicative of selection of the first shopping list by a second computing device of the plurality of shopper computing devices. The method includes based on accessing data indicative of selection of the first shopping list by the first computing device and the second computing device, computing a first subset of items for the first computing device and a second subset of items for the second computing device based on (i) features associated with the first computing device, (ii) features associated with the second computing device, and (iii) the characteristic data of each respective item of a plurality of items. The method includes transmitting data including instructions, that, when executed by the first computing device, cause an interactive user interface of the first computing device to provide the first subset of items for display via the interactive user interface of the first computing device.

Yet another example aspect of the present disclosure is directed to one or more non-transitory computer readable media storing instructions that are executable by one or more processors to perform operations. The operations include accessing data including a centralized data structure including a plurality of order requests, wherein each order request of a centralized list of order requests includes a plurality of data objects, each data object being indicative of an item. The operations include computing, based on a first order request of the centralized list of order requests and merchant location data, a shopping list including: (i) the plurality of data objects for items to be retrieved for the first order and (ii) characteristic data for each respective item. The operations include storing the computed shopping list and a plurality of other additional shopping lists in a shopping list data store, the shopping list data store accessible to a plurality of shopper computing devices. The operations include accessing data indicative of selection of the first shopping list by a first computing device of the plurality of shopper computing devices. The operations include automatically updating, based on accessing the data indicative of the selection of the first shopping list, the shopping list data store to include order status data. The operations include accessing data indicative of selection of the first shopping list by a second computing device of the plurality of shopper computing devices. The operations include based on accessing data indicative of selection of the first shopping list by the first computing device and the second computing device, computing a first subset of items for the first computing device and a second subset of items for the second computing device based on (i) features associated with the first computing device, (ii) features associated with the second computing device, and (iii) the characteristic data of each respective item of a plurality of items. The operations include transmitting data including instructions, that, when executed by the first computing device, cause an interactive user interface of the first computing device to provide the first subset of items for display via the interactive user interface of the first computing device.

Other example aspects of the present disclosure are directed to other systems, methods, apparatuses, tangible non-transitory computer-readable media, and devices for performing functions described herein. These and other features, aspects and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example computing ecosystem according to example aspects of the present disclosure.

FIG. 2 depicts a block diagram of an example flowchart for dynamic order splitting according to aspects of the present disclosure.

FIG. 3 depicts an example flow chart method for dynamic order splitting according to aspects of the present disclosure.

FIG. 4 depicts a block diagram of an example data structures used for dynamic order splitting according to aspects of the present disclosure.

FIG. 5 depicts a block diagram of an example data structures used for dynamic order splitting according to aspects of the present disclosure.

FIG. 6 depicts a block diagram of an example data structures used for dynamic order splitting according to aspects of the present disclosure.

FIG. 7 depicts a block diagram of an example data structures used for dynamic order splitting according to aspects of the present disclosure.

FIG. 8 depicts a block diagram of an example data structures used for dynamic order splitting according to aspects of the present disclosure.

FIG. 9 depicts a block diagram of an example data structures used for dynamic order splitting according to aspects of the present disclosure.

FIG. 10 depicts a block diagram of an example data structures used for dynamic order splitting according to aspects of the present disclosure.

FIG. 11 depicts an example user interface for dynamic order splitting according to aspects of the present disclosure.

FIG. 12A to FIG. 12C depict example user interface for dynamic order splitting according to aspects of the present disclosure.

FIG. 13A to FIG. 13C depict example user interface for dynamic order splitting according to aspects of the present disclosure.

FIG. 14A to FIG. 14B depict example user interface for dynamic order splitting according to aspects of the present disclosure.

FIG. 15A to FIG. 15B depict example user interface for dynamic order splitting according to aspects of the present disclosure.

FIG. 16A to FIG. 16B depict example user interface for dynamic order splitting according to aspects of the present disclosure.

FIG. 17 depicts an example merchant location associated with dynamic order splitting according to aspects of the present disclosure.

FIG. 18 depicts an example computing system diagram of an example computing system for dynamic order splitting according to aspects of the present disclosure.

### DETAILED DESCRIPTION

Generally, the present disclosure is directed to systems and methods for improving the efficiency of computing applications and computing resources associated with a distributed computing ecosystem including multiple client devices and one or more network computing systems (e.g., cloud-based systems). For instance, the technology of the present disclosure can be utilized to dynamically distribute data payloads among a plurality of hardware devices associated with a merchant location that are connected to a cloud-based delivery platform. This can be implemented through, for example, real-time order splitting and shopper claiming based on shopper client device data and shopping list item feature data for merchant locations that have multiple shoppers and orders active at the same time.

More particularly, aspects of the present disclosure can be used to determine when to designate a shopping list as eligible for splitting as well as how and when to dynamically update interactive user interfaces (e.g., graphical user interfaces (GUIs)) associated with multiple shopper computing devices to facilitate splitting the lists and completing the orders accordingly. By doing so, the technology described herein can improve the computational efficiency of the network computing systems as well as the distributed client devices connected thereto, by avoiding the duplication of data across the client devices, allowing for more efficient completion of computational tasks, without resource-intensive re-work by the network and client computers.

Moreover, the computing system and methods of the present disclosure can intelligently determine opportunities for data payload distribution based on the status of computing devices in the network. For example, the network computing system can track (e.g., via digital checklists, GPS pings) the progress of a client device being used by a shopper to fill an order and/or the progress of a client device used by a courier that is driving to the merchant location. The network computing system can utilize this information in real-time to determine whether data indicative of an order should be split among client devices of multiple shoppers (e.g., to allow for quicker shopping). For instance, if a shopper is taking longer than usual or is predicted to complete shopping for an order after a courier is scheduled to arrive to pick up the order, the network computing system can determine that the order can be split and, in some instances, can encourage the order being split. This can occur by transmitting a real-time message to a first shopper indicating they can request the order to be split or transmitting a real-time message to a second shopper indicating that an active order is available to be split.

The network computing system can intelligently compute how to split data payloads among the plurality of client devices. For example, the data indicative of the shopping list can be intelligently divided among the shoppers' client devices based on the characteristics of the items to be shopped, the characteristics of the shoppers, the progress, etc. The network computing system can continuously monitor the shoppers' client devices to determine whether to reassign certain data (e.g., a shopping item) from one client device to another and generate updated UI instructions regarding the same. In this way, the technology of the present disclosure can continue to distribute the computational load among the client devices, to ensure efficient order completion while improving the computational load on respective client devices (saving valuable computing resources).

Existing methods provide for grouping items within lists and generating paths for shoppers, however, these methods fail to provide for centralized management of shopping for a single order across multiple devices and users while providing for real-time order progress and dynamically adjusting the interactive user interfaces of respective computing devices to present the subset of items for a user to shop.

Reference now will be made in detail to embodiments, one or more example(s) of which are illustrated in the drawings. Each example is provided by way of explanation of the embodiments, not limitation of the present disclosure. In fact, it will be apparent to those skilled in the art that various modifications and variations can be made to the embodiments without departing from the scope of the present disclosure. For instance, features illustrated or described as part of one embodiment can be used with another embodiment to yield a still further embodiment. Thus, it is intended that aspects of the present disclosure cover such modifications and variations.

For example, the following describes the technology of this disclosure within the context of a number of shopper client devices (e.g., mobile shopper devices) within a grocery store for example purposes only. As described herein, the technology described herein is not limited to shopper client devices in grocery stores and can be implemented for or within any location where items are available for purchase and other computing systems.

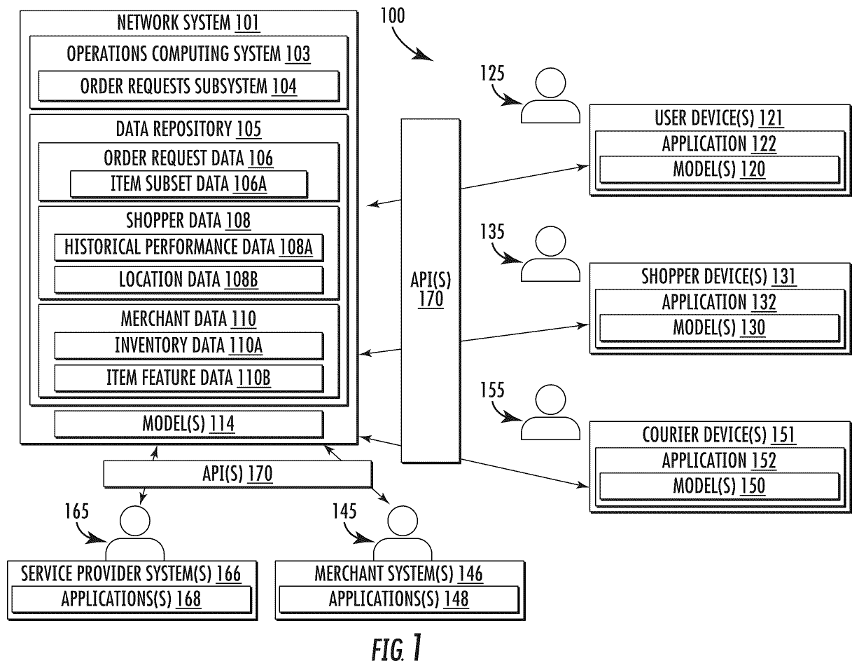

FIG. 1 depicts an example computing system 100 according to example aspects of the present disclosure. Example computing system 100 can include a network computing system 101, one or more users 125 associated with one or more user devices 121, one or more shoppers 135 associated with one or more shopper devices 131, one or more couriers associated with one or more courier devices 151, one or more merchants 145 associated with one or more merchant systems 146, and one or more service providers 165 associated with one or more service provider systems 166. In some examples, the one or more merchants 145 can be associated with shopper devices 131 (e.g., a designated shopper at a merchant location). Example computing system 100 can facilitate delivery services between users 125 and merchants 145 by utilizing shoppers 135 to retrieve requested items from merchant locations associated with merchants 145 and utilizing couriers 155 to retrieve the requested items from the merchant locations associated with merchants 145 to deliver the requested items to a drop-off location associated with an order request from one or more users 125. In some instances, couriers 155 can be shoppers 135. For instance, courier device 151 can include shopper device 131. In some instances, couriers 151 can retrieve requested items from merchant locations associated with merchant 145.

With respect to examples as described herein, the computing system 100 can be implemented on a server, on a combination of servers, or on a distributed set of computing devices which communicate over a network such as the Internet. For example, the computing system 100 can be distributed using one or more servers and/or client devices. In other examples, computing system 100 is implemented as part of, or in connection with a network computing system 101, where, for example, operators (e.g., shoppers 135, couriers 155, etc.) use service vehicles to provide delivery services for requesting users 125. In some examples, the computing system 100 can be implemented using client devices of users (e.g., user devices 121, shopper devices 131, courier devices 151) associated with users 125, shoppers 135, couriers 155, and merchants 145 with the individual devices executing a corresponding service application (e.g., application 122, application 132, application 152, application 148, application 168) that causes the computing device to operate as an information inlet and/or outlet for network computing system 101. In other examples, computing system 100 can be implemented using one or more merchant systems 146 associated with one or more merchants 145. In other examples, computing system 100 can be implemented using one or more service provider systems 166. Merchant system 146 or service provider systems 166 can operate as an information inlet and/or outlet for computing system 100 to exchange data with network computing system 101.

In some instances, applications on the client devices (e.g., e.g., application 122, application 132, application 152, application 148, application 168) can communicate with network computing system 101 via one or more application programming interfaces (APIs 170). APIs can include infrastructure to allow for sharing of data across computing system 100 without the data being in a standardized form utilizing a set of protocol and procedures.

Network computing system 101 can include a number of subsystems and components for performing various operations. For example, network computing system 101 can include an operations computing system 103, data repository 105, and one or more machine-learned models 114. Network computing system 101 can be any computing device that is capable of exchanging data and sharing resources. For example, network computing system 101 can include one or more networked devices configured to store or transmit data over physical or wireless technologies. In some examples, network computing system 101 can include hardware and software. In other examples, network computing system 101 can include physical equipment that is connected to a physical network.

Network computing system 101 can include an operations computing system 103. In some examples, operations computing system 103 can be implemented by one or more computing devices. For example, operations computing system 103 can include one or more processors and one or more memory devices. The one or more memory devices can store instructions executable by the one or more processors to cause the one or more processors to perform operations or functions associated with other subsystems or components of network computing system 101.

In some examples, operations computing system 103 can include an order request subsystem 104 configured to receive order requests from users 125 for delivery services. For example, a user 125 can submit a delivery service order request through an application 122 running on user device 121 associated with user 125. In some examples, order request subsystem 104 can receive a single delivery service order request from a user 125. In some examples, order request subsystem 104, can receive multiple delivery service order requests from multiple users 125 concurrently. In some examples, order request subsystem 104 can coordinate multiple delivery service order requests from the same user 125 which require selection or delivery of grocery items from multiple merchant locations.

Order request subsystem 104 can perform actions to coordinate a completion time of an order request, with an estimated time of arrival (e.g., of a courier) for requested items. In some examples, where merchant 145 or an individual associated with merchant 145 is associated with shopper device 131, order request subsystem 104 can coordinate actions to ensure a courier (e.g., individual delivering items to user 125) does not have to wait an extended period of time at the merchant location for merchant 145 to prepare the order request. For instance, network computing system 101 can determine that there are multiple available shoppers 135 associated with respective shopper devices 131. Network computing system 101 can dynamically distribute data objects associated with physical items (e.g., split an order request) among multiple shopper devices 131 based on data associated with the shoppers (e.g., shopper data 108), data associated with the order request (e.g., order request data 106), progress data associated with the order, and other relevant data (e.g., merchant data 110). In some instances, shopper device 131 can be capable of transmitting location data to network computing system 101. The location data can be indicative of a more granular location within a merchant location such that a store section, aisle, etc. can be identified.

In other examples, order request subsystem 104 can determine if there are insufficient resources to complete the delivery service order request. For example, insufficient resources can indicate there are no available couriers to deliver the requested grocery items. In some examples, order request subsystem 104 can reject a delivery service order request if there are insufficient resources (e.g., shoppers 135, couriers, etc.) to complete the grocery delivery order request. In other examples, order request subsystem 104 can offer alternative solutions (e.g., a later time or day) if there are insufficient resources to complete the delivery order request.

In some examples, order request subsystem 104 can provide data indicative of the delivery service request to other subsystems and components of network computing system 101 for further processing or storage. For instance, order request subsystem 104 can provide the data indicative of the delivery service request to data repository 105. Data repository 105 can include, for example, data stores such as relational databases, non-relational databases, key-value stores, full-text search engines, message queues, etc.

Data repository 105 can include order request data 106, shopper data 108, and merchant data 110. Such data can be encrypted, stored in a secure manner, pseudonymized, or optionally collected (e.g., as selected by a user 125). In some examples, data repository 105 can be replicated to ensure the data stored in data repository 105 is readily available for the plurality of user devices 121, shopper devices 131, courier devices 151, service provider systems 166, and merchant systems 146.

Shopper data 108 can include historical performance data 108A, location data 108B, and other shopper data. For instance, shopper data 108 can include data associated with shoppers 135 of the delivery service entity. In some examples, shopper data 108 can include user profile information (e.g., name, device type, shopper type (merchant versus courier) and user preferences (e.g., preferred items, categories, store locations).

Historical data 108A can include historical information associated with users 125 or merchants 145. For example, historical data can include a previous delivery service order requests that indicate items, merchant locations, and feedback from a user 125. In some examples, historical data can include the history of specific grocery item availability at a merchant location, completion time to prepare an order, etc.

In some examples, data repository 105 can be updated by user devices 121, shopper devices 131, and merchant systems 146. For example, as users 125 submits, via application 122 running on user device 121, a delivery service order request, data repository 105 can updated to reflect the delivery service request. In some examples, shopper device 131 can update, via application 132 running on shopper device 131, data repository 105 by providing updates (e.g., item unavailable, shopping complete, etc.) associated with the delivery service order request. In other examples, merchant systems 146 can update data repository 105 to reflect changes such as inventory levels at merchant locations, operating hours of merchant locations, etc. In some examples, data repository 105 can be updated dynamically (e.g., as events occur) or can be updated on a scheduled reoccurring basis. For instance, the applications on running on the respective devices can communicate with network computing system 101 via one or more API(s) 170 which can facilitate requests, data transmission, etc. between network computing system 101 and the respective applications on the respective devices. Data repository 105 can include order request data 106 which can be associated with the delivery service order request. For instance, the order request data 106 can include a number of items and associated feature data. For instance, the items can be individual items in a shopping list. Feature data can include characteristics associated with items such as selected quantity, item count, replacement indication, or other data associated with items. Additionally, or alternatively, order request data 106 can include a pick-up location, drop-off location, delivery instructions, promised delivery time, or other relevant data.

In some instances, order request data 106 can include item subset data 106A. For instance, the system (e.g., models 114) can determine that data objects (e.g., items) associated with an order request can be split across multiple shopper devices 131. As such, the order request data 106 can be split into a number of item subset data structures 106A. The item subset data structures 106A can be updated during the completion of an order based on item fulfillment, shopper speed, shopper device location, expected courier arrival time, or other input data used to determine data object distribution.

Data repository 105 can include shopper data 108. Shopper data 108 can include historical performance data 108A and location data 108B. Historical performance data 108A can include number of completed orders, complex order fulfillment history, order completion rate, replacement item satisfaction metrics, shopper rating, or other metrics associated with historical performance of a particular shopper (e.g., associated with a shopper identifier). Location data 108B can include location data obtained from location determining hardware of a shopper device 131. For instance, location data 108B can include near real-time location data which can provide insight into a location of a shopper device 131 within a merchant location such that the location data can be utilized by the system (e.g., and associated models) to determine allocation of the data objects associated with the respective shopping lists to the respective distributed shopper devices 131.

Data repository 105 can include merchant data 110. Merchant data 110 can include inventory data 110A and item feature data 110B. Inventory data 110A can include data regarding available items, item identifiers (e.g., stock keeping unit (SKU), universal product code (UPC), European article number (EAN), global trade item number (GTIN), or other product identifier), number of items in stock, restock dates and times (e.g., most recent restock, next planned restock), or other inventory related data.

Item feature data 110B can include data such as category of an item, special designation of an item, location of an item, similar items, items often shopped together, or any other feature data. A category of an item can include frozen, perishable, non-perishable, non-edible, refrigerated, shelf stable, produce, canned goods, outside aisle, pharmacy, bakery, snacks, or beverages. A special designation of an item can include, for example, refrigerated, age restriction, fragile, or special packaging.

Data repository 105 can include user data which can include data associated with users 125 of the delivery service entity. In some examples, user data can include user profile information (e.g., name, address, payment information) and user preferences (e.g., replacement item indicators, preferred brands, ripeness level of produce grocery items) of users.

In some examples, one or more machine-learned models 114 can utilize the data stored in data repository 105. By way of example, the one or more models 114 can be or can otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks.

For example, one or more models 114 can obtain user data including user preferences, shopper data 108 including historical performance data 108A and location data 108B, and merchant data 110 including inventory data 110A and item feature data 110B, to determine a dynamic allocation of data objects among shopper devices 131 for items of a current delivery service order request. In some examples, the one or more models 114 can include a data object allocation model trained to determine an allocation of data objects associated with items among shopper devices 131.

As indicated, computing system 100 can include various users 125 and user devices 121. Users 125 can include individuals, or a group of individuals associated with a user profile configured to interact with a delivery service entity. In some examples, users 125 can utilize a guest profile (e.g., one time use) to interact with the delivery service entity. User device 121 can include a mobile computing device, such as handheld point of sale device, a smartphone, tablet computer, laptop computer, VR or AR headset device, a device including a barcode scanner or other sensor, and the like. As such, user device 121 can include components such as a microphone, a camera, a satellite receiver, and a communication interface to communicate with external entities using any number of wireless communication protocols. In some examples, user device 121 can store a designated service application (e.g., application 122) in a local memory. In some examples, the memory can store additional applications executable by one or more processors of user device 121, enabling access and interaction with one or more host servers over one or more networks. In some examples, user devices 121 can communicate with network computing system 101 over one or more networks.

User devices 121 can be associated with users 125 and allow user 125 to interact with the delivery service entity (e.g., network computing system 101). For example, in response to user input by a user 125, application 122 can interact with user device 121 to display an application interface on a user interface of user device 121. In some examples, user 125 can select items and submit a delivery service order request through application 122 running on user device 121. In some examples, user 125 can view order updates (e.g., order in progress, complete, unavailable items, etc.) on the user interface of the user device. In some examples, user 125 can view an ETA (estimated time of arrival) for the order request.

In some examples, user device 121 can receive data from network computing system 101. For example, application 122 can receive data stored in data repository 105 of network computing system 101. In some examples, application 122 can interact with user device 121 to display historical data (e.g., a user's order history). In some examples, application 122 can interact with user device 121 to display merchant data 110 (e.g., available grocery items available at a merchant location). In other examples, application 122 can interact with user device 121 to display suggestions for grocery items that are likely to be desired by user 125.

For example, the one or more models 114 can include a user preference model trained to determine the preferences of a user 125. For example, the user preference model can utilize user data containing user preference selections and historical data containing an order history of user 125 to determine the preferences of user 125 for a current order request. In some examples, application 122 can interact with user device 121 to display the suggested items determined by the one or more models 114 of network computing system 101. For example, the one or more models can include a suggested item model trained to determine suggested items based on data stored in data repository 105. In other examples, application 122 can interact with user device 121 to display suggested user preferences for currently selected items (e.g., items in the user's cart) prior to the user submitting the order request.

In some examples, user device 121 can transmit preference data to network computing system 101. For example, application 122 can interact with the user interface of user device 121 to display selectable options for user 125. For example, application 122 can interact with user device 121 to display user preference options. In some examples, user 125 can indicate a preference for replacement items. For instance, a preference for replacement items can include not replacing an item, requesting a recommendation for a replacement item, automatically selecting the best available alternative, or otherwise setting up rules relating to the replacement of various items (or item types). For instance, replacement preferences can vary based on associated merchant, type of item (e.g., produce versus trash bags), or other replacement options. Additionally, user preferences can include a preference that produce, or meat grocery items meet a preferred ripeness or fattiness level by interacting with (e.g., adjusting, sliding, swiping, typing, etc.) an interactive ripeness element (e.g., slider, menu) on the display of user device 121. In some examples, user 125 can indicate (e.g., prior to submitting an order request) that user preferences should be used for all future order requests. For example, user 125 can indicate (e.g., prior to submitting an order request) that user preferences should only be used for a current order request. For instance, application 122 can interact with user device 121 to display user preference options and user 125 can select a user interface element to indicate that user preference selections are only for the current order request. In other examples, user 125 can opt to not save the user preference selections.

In other examples, user 125 can update previously saved user preferences. For example, application 122 can interact with the user interface of user device 121 to display saved user preference options. User 125 can indicate updated user preferences by updating an item preference user interface element. For example, user 125 can indicate an updated user preference relating to replacement indication or an updated user preference that produce, or meat grocery items meet a preferred ripeness or fattiness level by interacting with (e.g., adjusting, sliding, swiping, typing, etc.) an interactive ripeness element (e.g., slider, menu) on the display of user device 121.

In some examples, user data can include user preferences. The user preference selections can be transmitted over one or more networks and stored in a data repository 105 of network computing system 101. In some examples, the user preference selections can be used as input data to one or more models 114 of network computing system 101 to determine an allocation of data objects among shopper devices 131.

In some examples, user device 121 can transmit feedback data to network computing system 101. For example, application 122 can interact with user device 121 to display a feedback element on the user interface of user device 121. User 125 can provide feedback indicating satisfaction or dissatisfaction with the delivery service. In some examples, user 125 can indicate feedback associated with user preferences, replacement items, or order fulfillment.

For example, application 122 can interact with the user interface of user device 121 to display a feedback user interface element. In some examples, the feedback user interface element can be displayed after user 125 has received the requested grocery items. For example, user 125 can indicate that a specified replacement preference (e.g., no replacement, best alternative, recommend a replacement) or specified item preference (e.g., a produce ripeness level) was satisfied by providing a rating (e.g., rating on a rating scale or text via a rich text editor, etc.). In some examples, user 125 can indicate that a specific item preference was not satisfied by providing a rating (e.g., rating on a rating scale or text via a rich text editor, etc.). In some examples user data can include feedback data captured by the feedback user interface element. In other examples, historical data can include feedback data captured by the feedback user interface element. The user feedback data can be captured by the feedback user interface element via the display of user device 121 and transmitted to network computing system 101 and stored in data repository 105. In some examples, the user feedback data can be used to train models 114 of network computing system 101. For instance, user feedback data can be associated with a merchant and/or shopper and can be utilized to update historical performance data 108A and/or item feature data 110B.

The computing system 100 can include shoppers 135 and shopper devices 131. A shopper 135 can be used to retrieve requested items from a merchant location. In some examples, shopper 135 can include the courier (e.g., individual transporting requested grocery items), or an individual associated with a merchant 145 (e.g., a designated shopper at a merchant location). Shopper device 131 can include a mobile computing device, such as a smartphone, tablet computer, laptop computer, VR or AR headset device, and the like. As such, shopper device 131 can include features such as a microphone, a camera, a satellite receiver, and a communication interface to communicate with external entities using any number of wireless communication protocols.

In some implementations, shopper device 131 can be a courier device via which a courier receives data associated with the delivery service request. This can include instructions for traveling to a merchant location associated with one or more merchants 145, items selected by a user 125, instructions for shopping for one or more items associated with a delivery service request, etc.

In some implementations, shopper device 131 can be a mobile computing device associated with a merchant location. This can include a dedicated tablet, phone, etc. that is utilized by a shopper 135 within the merchant location. In some instances, shopper device 131 can include an authentication interface to associate a particular shopper 135 with shopper device 131 for fulfillment of a particular order, during a shift. Shopper device 131 can receive, for a merchant 145, data that is associated with the delivery service order request such as order request data 106. This can include items selected by a user 125, pick-up times, etc. In some implementations, a shopper device 131 can be communicatively connected to a computing system of the merchant location (e.g., inventory systems, POS systems, etc.).

In some examples, shopper device 131 can store a designated service application (e.g., application 132) in a local memory. In some examples, the memory can store additional applications executable by one or more processors of shopper device 131, enabling access and interaction with one or more host servers over one or more networks. In some examples, shopper devices 131 can communicate with network computing system 101 over one or more networks. In some examples, shopper devices 131 can communicate with network computing system 101 via one or more API(s) 170. In some instances, applications can include an aggregator application. For instance, an aggregator application can collect data indicative of a number of order requests from a number of different delivery service platforms (e.g., associated with one or more service providers 165 which are associated with one or more service provider systems 166).

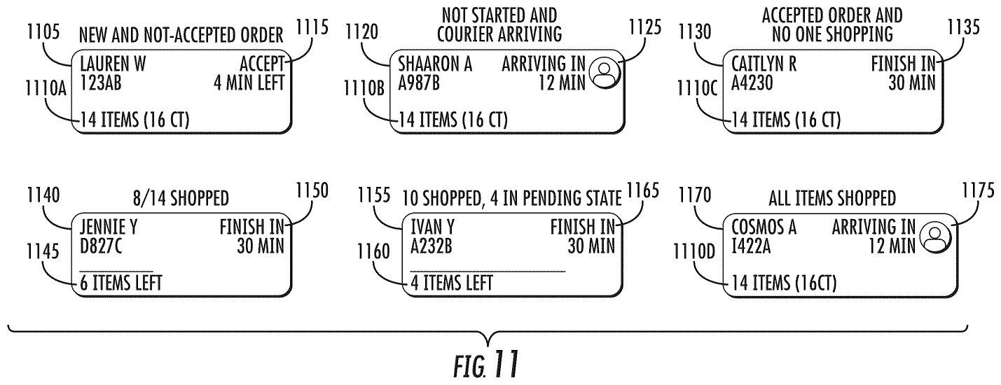

Shopper devices 131 can be associated with shoppers 135 and allow the shopper 135 to interact with the delivery service entity. For example, in response to user input by a shopper 135, an application 132 can interact with shopper device 131 to display an application interface on a user interface of shopper device 131. Example user interfaces of a shopper device are further described with reference to FIG. 11A to FIG. 16C. Additionally, or alternatively, shopper devices 131 can include courier devices 151 and/or be associated with couriers 155. For instance, couriers 155 can perform the item retrieval portion of a service within a merchant location.

In some examples, shopper device 131 can receive, over one or more networks, data from network computing system 101. For example, application 132 can receive data stored in data repository 105. In some examples, application 132 can interact with shopper device 131 to display merchant data 110 (e.g., merchant location, item locations within merchant location, etc.). In other examples, application 132 can interact with shopper device 131 to display user data (e.g., user preferences, essential items, etc.). In other examples, application 132 can interact with shopper device 131 to display shopper data 108 (e.g., historical performance data 108A or location data 108B).

In some implementations, application 132 running on shopper device 131 can make a call to merchant systems 146 via one or more API(s) 170 to hydrate application 132. Hydrating application 132 can include filling one or more objects associated with the application with data. In some instances, an application can be partially hydrated to save on computing resources by only loading necessary information. Partial hydration can allow for reduction in bandwidth and computer processing unit cycles for data that is not actively being used. For instance, one or more API(s) 170 can include a claim order API. The merchant system 146 can obtain the request and determine an identifier associated with the device and/or an authenticated account associated with the shopper device 131 that is making the call. Utilizing the claim order API, shopper device 131 can claim one or more available orders as described herein. In some instances, the ability to claim certain orders can be dependent on a shopping mode associated with the shopper device 131. For instance, a shopping mode can include a solo shopping mode or a co-shop shopping mode. When in solo shopping mode, a shopper device 131 can be prevented from joining a shopping order that is currently claimed by another shopper device. Alternatively, co-shop shopping mode can allow a shopper device 131 to join a shopping order that is currently claimed by another shopper device. In some instances, multiple shopper devices in solo shopping mode can attempt to claim a shopping order at the same time. The computing system can perform an optimization process to determine which shopper device to assign the order to. When an order is claimed or otherwise assigned, data repository 105 can be updated to reflect that the order has been assigned, and in some instances, the associated identifier that is assigned to the order (e.g., as depicted in FIG. 4).

Application 132 can interact with shopper device 131 to display order request data 106 such as item subset data 106A. In some instances, application 132 can interact with shopper device 131 to facilitate the recommendation or selection of distributing data objects associated with an order (e.g., splitting items) across multiple shopper devices. Distributing data objects associated with an order can be performed at designated times in an order request workflow. Additionally, or alternatively, distributing data objects associated with an order can be performed periodically throughout the fulfillment of an order request (e.g., as each shopper is making progress and moving around the merchant location to fulfill the order).

In some instances, application 132 can display a read-only interface for an unclaimed order. Responsive to obtaining user selection of “join order” or some other initiation, the application 132 can update to allow for interaction via the user interface of shopper device 131 with application 132 to view order details, mark items as shopped, or otherwise interact with the order (and thus updating the data repository 105 to update data associated with order).

In some instances, application 132 can include an authentication service. For instance, a shopper can utilize authentication service to identify themselves to the application 132 and associate themselves with shopper device 131 for a shopping session. Authentication can allow for the data repository 105 to be updated to reflect shopping metrics associated with the shopper identifier. For instance, a shopper can log-in using existing credentials. Additionally, or alternatively, application 132 can include an interface flow for setting up an account. This can include providing a username, password, or other profile information.

Shopper device 131 can include one or more machine-learned models 130 configured to improve the data object distribution and/or item selections for the requested items. As examples, the one or more models 130 can be or can otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks. For example, the one or more models 130 can obtain order request data 106 including item subset data 106A, shopper data 108 including historical performance data 108A and location data 108B, user data including user preferences, and merchant data 110, to determine a distribution of data objects, user preference suggestion for items of a current delivery service order request, or a recommended route through a merchant location.

In some examples, one or more models 130 can include a data object distribution model trained to distribute data objects associated with various items in an order across multiple shopper devices. In some instances, one or more models 130 can personalized to an account associated with a shopper device 131, or a merchant. In some examples, the one or more models 130 can include an item detection model trained to detect grocery items available at a merchant location. In some examples, the one or models 130 can include an item recommendation model trained to determine a recommended grocery item from the available grocery items at a merchant location. In some examples, the item detection and item recommendation models can be trained to utilize data from data repository 105. For example, the historical data (e.g., previously requested grocery items) and user data (e.g., user preference data, user feedback, etc.) can be input to the one or more models 130 to improve the grocery item selections for the requested grocery items.

In some examples, shopper device 131 can transmit data to network computing system 101. For example, application 132 can interact with the user interface of shopper device 131 to display the subset of items assigned to a respective shopper device 131. For instance, the subset of items can include preferences associated with the items, replacement indications, location of the items within the store, count of the respective items, and a ready time associated with the items to be shopped. Additionally, application 132 can interact with the user interface of shopper device 131 to provide various interactive interface elements. The example interactive interface elements can be utilized to facilitate encouraging the splitting of orders, opting into to splitting of orders, and/or providing messages associated with the splitting of orders. In some instances, the user interface of user device 121 can display the output indicative of the recommended replacement grocery item (e.g., image of the selected item including the available items) as an update to the order request that the item was selected (e.g., shopped) by the shopper 135. In some examples, the user interface of user device 121 can display the output indicative of the recommended grocery item after the grocery items have been delivered to solicit feedback from user 125. Examples of the one or more interactive interface elements are further described with reference to FIG. 11A to FIG. 16D.

In some examples, shopper device 131 can transmit data to network computing system 101. For example, application 132 can interact with user device 121 to indicate updates associated with the order request. For example, the shopper 135 can provide updates indicating that a requested item has been completed (e.g., item was available and selected by the shopper). In some examples, the shopper 135 can provide updates indicating that a requested grocery item is unavailable (e.g., out of stock). In other examples, the shopper 135 can provide updates indicating one or more replacement suggestions. The updates associated with the order request can be transmitted over one or more networks and stored in a data repository 105 of network computing system 101. In some examples, the updates can be used to train the models 114 of network computing system 101.

Computing system 100 can include merchants 145 and merchant systems 146 that operate as an information inlet and/or outlet for the computing system 100 to exchange data with network computing system 101. Merchants 145 can include any person or company involved in the trade or sale of items (e.g., grocery items). Merchants 145 can be associated with merchant locations (e.g., physical locations, grocery stores, etc.) where grocery items can be purchased. Example merchant locations include conventional supermarkets, limited assortment supermarkets, supercenters, warehouse clubs, or convenient stores. In some examples, merchants 145 can be associated with shopper devices 131. For example, merchants 145 can offer merchant shopper services (e.g., a designated shopper at a merchant location) to select grocery items requested using the delivery service entity. In some examples, merchants 145 associated with a shopper device 131 can perform similar operations as a shopper 135 as described herein. In some instances, merchant systems 146 can interface with a number of service provider systems 166 to facilitate orders from a number of delivery service entities. In some instances, shopper devices 131 can be associated with a single delivery service (e.g., on service provider of a plurality of service provider systems 166).

Merchant systems 146 can be associated with one or more merchants 145. Merchant systems 146 can include a record for each merchant 145 subscribed to the delivery service entity (e.g., associated with service provider systems 166) as well as associated merchant locations. By way of example, merchant systems 146 can aggregate inventory data for each respective merchant location to define grocery items that are available at each merchant location associated with the respective merchants 145. In some examples, merchant systems 146 can include the location of grocery items that are available within each specific merchant location. Merchant systems 146 can be updated by merchant 145 to reflect the most up to date inventory levels at the respective merchant locations associated with the merchants 145. In some examples, merchant systems 146 can synchronize within inventory management software, point-of-sale systems, etc. of one or more merchants 145 to maintain accurate levels of inventory at each respective merchant location.

In some examples, merchant systems 146 can transmit merchant data 110 to network computing system 101. For example, a merchant system 146 can be updated (e.g., by an individual associated with the merchant 145, automatically, via one or more API(s) 170) etc.) to indicate that a particular item is no longer available at a merchant location associated with the merchant 145. In some examples, a merchant system 146 can be updated to indicate that previously unavailable grocery items are now available at a merchant location associated with merchant 145.

Merchant system 146 can transmit updated merchant data 110 indicating the change in inventory to network computing system 101. In some examples, network computing system 101 can utilize the updated merchant data 110 for processing order requests from users 125 of the delivery service entity.

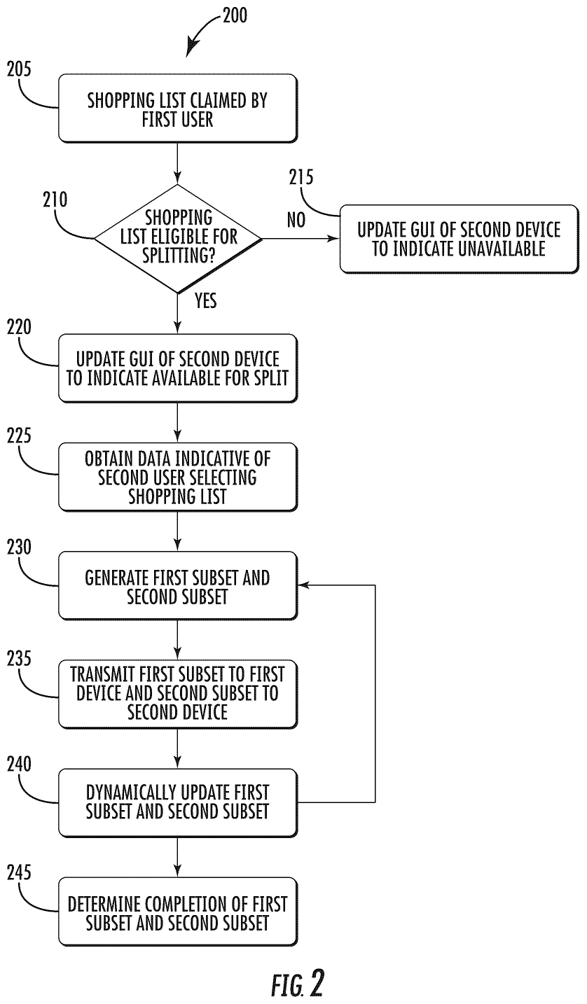

As described herein, network computing system 101 can include data flow to and from various devices and systems. An example dataflow diagram is described with reference to FIG. 2.

FIG. 2 depicts an example dataflow 200 diagram for dynamic data object distribution based on historical performance and/or real-time data according to example embodiments of the present disclosure. Dataflow 200 can include the shopping list being claimed by a first user at operation 205. For instance, data indicative of user selection of a shopping list can be received via a user interface of a client device (e.g., shopper device). Responsive to the input indicative of user selection, a data object associated with the shopping list can be generated and/or updated to reflect that the shopping list has been claimed. For instance, the data object can be updated such that when an application interacts with a respective client device to display data associated with various orders stored within a data repository, the interface of the client device will include a visual indication associated with the claimed order being selected.

Rather than the order/shopping list being locked/prevented from being claimed by another shopper, the order/shopping list can be available for another shopper to claim.

At operation 210 the computing system can determine if the shopping list is eligible for splitting. If the computing system determines that the shopping list is not available for splitting, at operation 215, the computing system can update a graphical user interface of a second device to indicate that the shopping list is unavailable. For instance, the computing system can generate or update a data object associated with the shopping list that provides for displaying an indication that the shopping list is not available for splitting.

In some instances, the criteria for determining whether a shopping list is eligible for splitting can be determined based on a number of items, progress of the first user, types of items, or other order related data. Additionally, or alternatively, the criteria for determining whether a shopping list is eligible for splitting can be determined based on overall system activity. Overall system activity can include a number of active order requests and a number of active shopper devices. For instance, the number of active shopper devices can be determined based on utilization of system resources such as number of API calls, data usage, bandwidth usage, power usage, etc. The network traffic data being utilized by the shopper devices can be utilized to determine whether the devices are associated with active order requests. Based on the number of active order requests, and the number of active shopper devices, the system can determine whether to update a status associated with the shopping list as available or unavailable. For instance, if a number of shopper devices are active is greater than the number of active order requests, this can be a signal that could be utilized to denote the shopping list as eligible for splitting.

In some instances, the computing system can determine that the shopping list is available for splitting. Responsive to this determination, the computing system can, at operation 220, generate or update a data object associated with the shopping list to indicate that the order is eligible to be split. For instance, the data object can include data such that an application associated with a shopper device causes a selectable user interface element depicting a message such as, “join this order” to be provided for display via a shopper device.

For instance, the second device can access a data repository of network computing system. The second device can make a call for one or more data objects associated with the shopping list. When accessed by the second computing device, the data objects can cause the GUI of the second computing device to provide the shopping list as eligible for splitting (e.g., including one or more selectable interactive user interface components associated with the shopping list) for display.

In some implementations, the second device can include a prompt for a user of the device to select a shopping mode. For instance, a shopping mode can include “solo” mode or “co-shopping” mode. A device associated with solo shopping mode can be prevented from joining an existing order. A device associated with co-shopping mode can be allowed to view and/or select an option to “join this order” and co-shop an order that is assigned to another shopper. For instance, the computing system can access a datastore including an indication of whether the order is assigned and/or information relating to an identifier that the order is assigned to. The identifier can include a device identifier, user identifier, or any other identifier.

At operation 225, the computing system can obtain data indicative of the second user selecting the shopping list. For instance, the user can select the selectable user interface element depicting a message such as, “join this order.” Responsive to obtaining data indicative of the selection of the shopping list, the computing system can, at operation 230, generate a first subset of items and a second subset of the items. The first subset of items and the second subset of items can be determined based on the progress of a client device associated with the first user (e.g., via a digital checklist, GPS ping), the progress of a client device associated with a courier, one or more item characteristics, and one or more historical performance metrics associated with the respective shopper.

At operation 235, the computing system can transmit the first subset of items to the first device and the second subset of items to a second device.

At operation 240, the computing system can dynamically update the first subset of items and the second subset of items to generate an updated first subset of items and second subset of items. For instance, the computing system can loop back to operation 230 and re-generate the first subset of items and second subset of items. The dynamic updating of the first subset of items and second subset of items can be performed periodically while the order request associated with the shopping list is still pending. Additionally, or alternatively, the dynamic updating can be triggered by one or more progress updates. Progress updates can include physical location changes, a percentage or number of items being marked as completed, or some other progress indicator associated with the first shopper device and second shopper device.

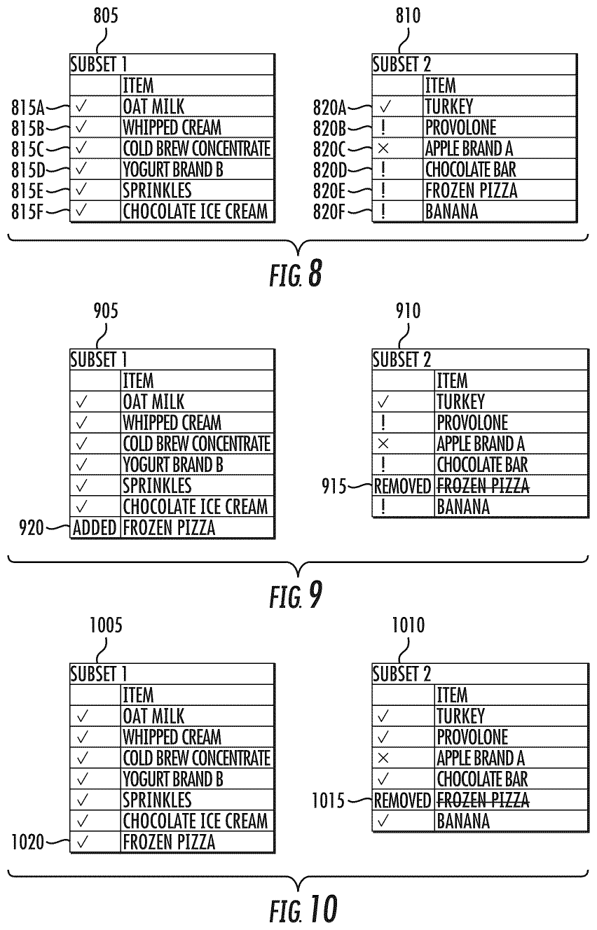

At operation 245, the computing system can determine completion of the first and second subset. For instance, operation 245 can include accessing a data structure (such as data structures depicted in FIG. 8, FIG. 9, and FIG. 10 to determine a status associated with the data object (e.g., in progress, completed, or unavailable). In some instances, the computing system can determine that each data object has either a completed or unavailable status indicator. As such, the system can determine that the order has been completed.

Upon completion of the order, the computing system can log data associated with each of the subsets and each of the shopper devices in order to update metrics associated with the shoppers, items, and merchant. For instance, the historical data associated with the shoppers (e.g., historical performance data 108A) can be updated to include found rate, replacement rate, replacement approval, shopping speed, total orders, total items picked, fulfillment rate, average pick time, average basket size, fulfilled orders, missed orders, defected orders, or any other relevant metrics which can be utilized by the system to determine data object allocation and eligibility for split shopping lists for future order fulfillment. In some instances, relevant metrics can be broken down for different item types. For instance, a first shopper can perform better with picking items which require some subject judgment (e.g., ripeness of a fruit, cut of meat, size of produce) as such, their defect rate for that kind of item can be lower than another shopper associated with the same merchant.

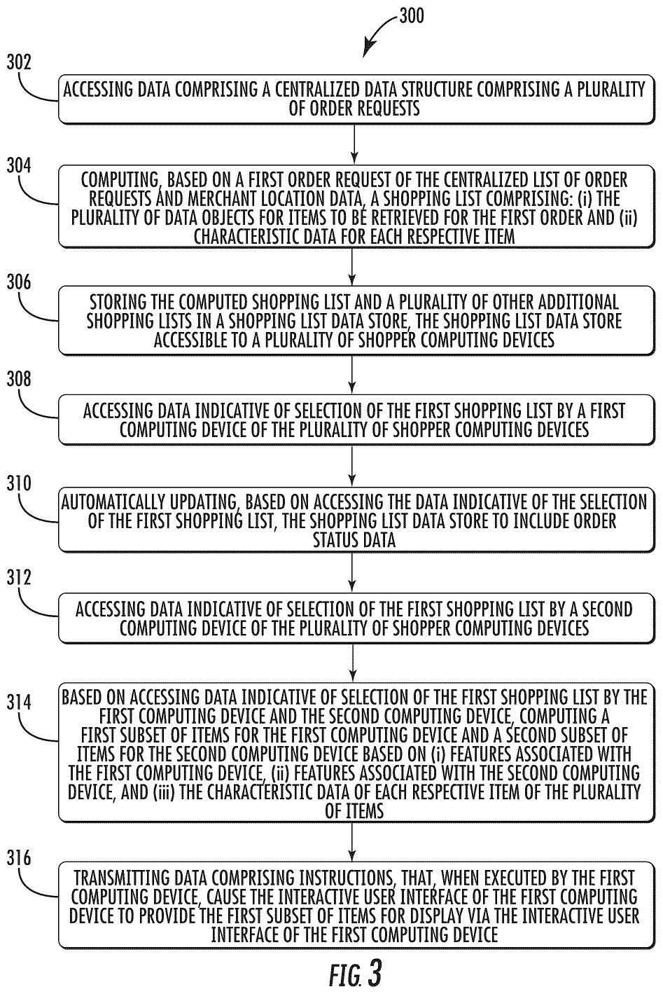

FIG. 3 depicts a flowchart diagram of an example method 300 to perform dynamic data object distribution based on historical performance in accordance with some embodiments of the present disclosure. Method 300 can be performed by processing logic that can include hardware (e.g., computing devices, processing devices, circuitry, programmable logic, dedicated logic, hardware of a device, microcode, integrated circuit, etc.), software (e.g., instructions that are executable or can run on a processing device), or a combination thereof. In some implementations, method 300 can be performed by network computing system (e.g., network computing system 101) which can be a distributed computing system (e.g., cloud-based systems). FIG. 3 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure, and some processes can be performed in parallel. In some embodiments, one or more processes can be omitted. Thus, not all processes are required by every embodiment. Additional or alternative process flows are possible.

At operation 302, processing logic can access data including a centralized data structure including a plurality of order requests. For instance, the centralized data structure can be one data structure of a number of hierarchical data structured stored or managed by the system. For instance, the hierarchical data structures can be organized such that updating data in one data structure can result in automatic adjustments to related data structures. For instance, a summary data structure including a number of orders and high level order details can be generated or updated based on a number of individual data structures associated with specific order requests.

At operation 304, processing logic can compute, based on a first order request of the centralized list of order requests and merchant location data, a shopping list including: (i) the plurality of data objects for items to be retrieved for the first order and (ii) characteristic data for each respective item. For instance, the shopping list can be generated based on the shopping list and merchant location data. The shopping list can include a number of data objects.

Each respective data object can be associated with an item of the delivery order request. The plurality of data objects for items to be retrieved for the first order can include, for example, a row in a table or some other discrete unit of a data structure with information associated with a particular item. Characteristic data for each respective item can include additional details relating to the item such as quantity, count, replacement indication which can be obtained as part of the order request. In some instances, the processing logic can access data structures associated with merchants and inventory to populate additional fields of the data object such as item location, item category, similar items, or other merchant related information associated with the respective item of the first order request.

At operation 306, processing logic can store the computed shopping list and a plurality of other additional shopping lists in a shopping list data store, the shopping list data store accessible to a plurality of shopper computing devices. For instance, a number of other additional shopping lists can be computed and stored. The shopping lists can be accessible by the respective shopper computing devices (e.g., via the applications on the respective devices) can communicate with a network system to access the number of shopping lists. For instance, the shopping lists can include data that when executed by the application and the shopper device, causes the number of shopping lists to be provided for display via the user interface of the shopper device.

In some implementations, the shopping lists in the shopping list data store can include shopping lists associated with merchant shoppers and courier shoppers. In some instances, a courier shopper can be associated with traveling to a merchant location, retrieving items associated with the order, and delivering the items to a drop-off location. The present disclosure can provide for determining that a courier's estimated time of arrival is later than initially determined (e.g., due to traffic, etc.). Based on the delayed estimated time of arrival, processing logic can highlight the courier shopping list for claiming by a second user. For instance, processing logic can move the courier shopping list to the top of the list, sending a real-time notification to shopper devices indicative of an option to claim the order to co-shop. If the list is selected for co-shopping, processing logic can generate the sublists of items. In some instances, the sublist of items for each shopper can include items that are non-perishable to the merchant shopper whereas items which require refrigeration or special storage can be reserved for or otherwise assigned to the courier shopper's sublist. As such, the determination to distribute the data objects associated with the items of the order can be made based, at least in part, on the courier's estimated time of arrival at the merchant location.

In some implementations, sublists can be generated based on multiple orders. For instance, a first shopper can be assigned refrigeration items for two or more orders and a second shopper can be assigned non-perishable items for two or more orders. Additionally, or alternatively, a first portion of two orders can be assigned to a single first shopper while a second portion of the two orders can be distributed among different shoppers. As such, the system can determine multiple allocation of data objects associated with items across shopper devices to provide for better utilization of system resources and completion of the order request.

At operation 308, processing logic can access data indicative of selection of the first shopping list by a first computing device of the plurality of shopper computing devices. In some instances, based on obtaining a request for the computed shopping list and the plurality of other additional shopping lists, processing logic can transmit data including instructions, that, when executed by a shopper computing device, cause presentation of the shopping list and the plurality of other additional shopping lists via an interactive user interface the shopper computing device. For instance, the first shopping list can be provided for display via a user interface of the shopper device. The user interface can include a selectable user interface element such as a button that can be “clicked” by a user to select or otherwise indicate that the user will proceed to fulfill the shopping portion of the order. The selection by a user can be any form of input such as touch, voice, etc. that is obtained by a sensor of the shopper device.

At operation 310, processing logic can automatically update, based on accessing the data indicative of the selection of the first shopping list, the shopping list data store to include order status data. The order status includes, for example: unclaimed, claimed and not begun, in progress, nearly done, or completed. For instance, an unclaimed order status can be indicative of an order which has not been claimed or otherwise selected by a shopper to perform. A claimed and not begun order status can be associated with an order that has been selected by a shopper device, but the system has since not received any updates regarding shopping progress or completion of items of the shopping list. In progress can include a claimed order where at least one item has been shopped or completed. Nearly done can include when a majority of a number of items have been shopped (e.g., 75% or greater completion, 4 or less items to go, or some other predetermined threshold). Completed can be associated with a shopping list where every item has a completed indicator or an unavailable indicator.

At operation 312, processing logic can access data indicative of selection of the first shopping list by a second computing device of the plurality of shopper computing devices. In some instances, based on obtaining a request for the computed shopping list and the plurality of other additional shopping lists, processing logic can transmit data including instructions, that, when executed by a shopper computing device, cause presentation of the shopping list and the plurality of other additional shopping lists via an interactive user interface the shopper computing device. For instance, the first shopping list can be provided for display via a user interface of the shopper device. The user interface can include a selectable user interface element such as a button that can be “clicked” by a user to select or otherwise indicate that the user will proceed to fulfill the shopping portion of the order. The selection by a user can be any form of input such as touch, voice, etc. that is obtained by a sensor of the shopper device.

At operation 314, processing logic can, based on accessing data indicative of selection of the first shopping list by the first computing device and the second computing device, compute a first subset of items for the first computing device and a second subset of items for the second computing device based on (i) features associated with the first computing device, (ii) features associated with the second computing device, and (iii) the characteristic data of each respective item of the plurality of items.

Features associated with the first computing device can include a shopper profile associated with the device, location data associated with the device, historical shop data associated with the device or a shopper profile. Features associated with the second computing device can include a shopper profile associated with the device, location data associated with the device, historical shop data associated with the device or a shopper profile. By way of example, the first computing device and second computing device can be associated with two different shoppers. Each shopper can associate the device with themselves using a means of authentication. This can include, for example, signing into an account of the respective shopper.

The first computing device (e.g., first shopper) can have a historical shopping history of a much larger number of orders fulfilled than the second computing device (e.g., second shopper). As such, the processing logic can determine that items with characteristic data associated with being more complex or requiring more discretion (e.g., produce, meat) can be distributed to the first subset of items such that the first shopper associated with the first computing device will be responsible for shopping for that item.

As an additional, or alternative example, the first computing device can have a higher replacement approval rating than the second computing device. As such, the first computing device can be associated with a subset of items that includes items marked with “best replacement item” or “provide recommended alternative”.

Characteristic data of each respective item of the plurality of items can include a replacement indication, a category, or item type. A replacement indication can include an indication of the proper means of adjusting the order if an item is out of stock or otherwise unavailable.

In some instances, computing first subset of items and the second subset of items is performed responsive to accessing data indicative of the first computing device indicating a need for assistance. In some instances, computing the first subset of items and the second subset of items is performed responsive to determining that a courier associated with picking up the first shopping list will arrive before the first computing device completes the shopping list.

The features associated with the first computing device and the features associated with the second computing device can include the historical performance of the operator (e.g., shopper, courier) associated with the respective device or experience level of the operator associated with the respective device. The historical performance of the operator can include an aggregation of metrics associated with past order fulfillment instance. The metrics can include at least one of: (i) an order replacement satisfaction rate, (ii) a shop time, or (ii) a wait time for a courier picking up the order. The experience level of the operator can be determined based on at least one of: (i) a number of previously completed orders or (ii) characteristics of previously completed orders.

The characteristic data of each respective item of the plurality of items can include at least one of: (i) an item type, (ii) an item location, or (iii) an item category. The item type can include at least one of: (i) frozen, (ii) perishable, (iii) non-perishable, (iv) non-edible, (v) refrigerated, or (vi) shelf stable. The item category can include at least one of: (i) an indication of produce, (ii) canned goods, (iii) outside aisle, (iv) pharmacy, (v) bakery, (vi) snacks, (vii) beverages, or (viii) frozen goods.

Computing a first subset of items for the first computing device and the second subset of items for the second computing device can include determining a percent completion of the first shopping list. Based on the percent completion of the first shopping list exceeding a predefined range, updating the order status data to indicate that the order cannot be selected by a second computing device. Additionally, or alternatively, based on the percent completion of the first shopping list being below a predefined range, the order status data can be updated to indicate that the order can be selected by a second computing device.

At operation 316, processing logic can transmit data including instructions, that, when executed by the first computing device, cause the interactive user interface of the first computing device to provide the first subset of items for display via the interactive user interface of the first computing device.

In some instances, processing logic can transmit data including instructions, that, when executed by the second computing device, cause the interactive user interface of the second computing device to provide the second subset of items for display via the interactive user interface of the second computing device. Processing logic can compute a first progress metric for the first computing device and a second progress metric for the second computing device. The first progress metric can be indicative of an amount of completion of the first subset of the first shopping list. The second progress metric can be indicative of an amount of completion of the second subset of the first shopping list. Based on the first progress metric and the second progress metric, the processing logic can periodically transmit instructions, that when executed, cause at least one of: (i) the interactive user interface of the first computing device or (ii) the interactive user interface of the second computing device to be updated.

For instance, processing logic can access current location data indicative of a real-time location of the first computing device and a real-time location of the second computing device within the merchant location. Based on (i) the current location data, (ii) the first progress metric, and (iii) the second progress metric, the processing logic can dynamically adjust a distribution of items between the first subset of items and the second subset of items. Based on dynamically adjusting the distribution of items, the processing logic can automatically transmit instructions which cause the interactive user interface associated with the first computing device to provide, for display, an updated first subset of items and the interactive user interface associated with the second computing system to provide for display an updated second subset of items.

As described herein, dynamically adjusting the distribution of items between the first subset of items and the second subset of items can include removing one or more items from the first subset of items and adding the one or more removed items to the second subset of items.

As described herein, the processing logic can determine a replacement item is needed for a first item of the first subset of items. Based on a location of a recommended replacement item and the current location data, the processing logic can update the second subset of items to include the replacement item. The processing logic can transmit data including instructions that, when executed by the second computing device, cause the interactive user interface of the second computing device to provide the updated second subset of items for display via the interactive user interface of the second computing device. For instance, the location of the recommended replacement item and the real-time location of the second computing device can be within a predefined threshold.

The data flow described in FIG. 2 and method described in FIG. 3 can generate, access, and update various data structures. Examples of a data structures that can be stored in or associated with data repository 105 and with data flow 200 and method 300 are described with reference to FIG. 4 to FIG. 10.

FIG. 4 depicts an example data structure 400 of a memory according to example embodiments of the present disclosure. Example data can include Merchant A orders 405. For instance, each respective merchant (e.g., associated with merchant systems 146), can have associated data objects for the respective orders. The data objects can include an order identifier 410, a number of items 415, a number of units 420, order assignment 425, and ID(s) assigned 430. The order identifier 410 can include a name, numerical identifier, or any other unique identifier to distinguish the respective data objects from one another in the data structure 400. The number of items 415 can be indicative of the number of distinct items associated with the data object (e.g., total number of SKUs, etc.). The number of units 420 can include the total number of items including a count for any duplicates associated with a particular item type. Order assigned 425 can include an indication of whether the order has been assigned to an identifier (e.g., device identifier, shopper identifier). For instance, a true indication can be indicative of the order being assigned and a false indication can be indicative of the order not yet being assigned. ID(s) assigned 430 can include an indication of which identifier (e.g., device identifier, shopper identifier) has been assigned to the order. In some instances, this can include a single identifier, in some instances this can include multiple identifiers. In some instances, this can include a false designation if the order has not been assigned an identifier. Data structure 400 can include additional information associated with the respective data objects which can be used by the computing system (e.g., network computing system 101) to dynamically adjust distribution of payload relating to the data objects.

FIG. 5 depicts an example data structure 500 of a memory according to example embodiments of the present disclosure. Example data can include data associated with a first data object from FIG. 4. For instance, data object associated with order “name A” can be associated with an additional data structure 500 which can include additional details associated with the Name A order 505. For instance, the data structure 500 associated with Name A order 505 can include a number of items 510, a number of units 515 of each respective item, the aisle 520 (e.g., location) of each respective item, a category 525 of each respective item, and a replacement indication 530 for each respective item.

As such, for each item, a data object (e.g., group of cells, concatenated string of identifiers) can be generated and stored in memory. The items 510 can include a plain language identification of an item including a brand name or description. The number of units 515 can indicate a number of units to be added. For instance, items can include brand A apple, oat milk, chocolate bar, brand B yogurt, turkey, provolone, chocolate ice cream, sprinkles, whipped cream, frozen pizza, cold brew concentrate, and bananas. The number of units of each item can be included in the data object. For instance, two brand A apples, two brand B yogurts, three bananas, and one of each remaining item.

Aisle 520 can include an aisle or other store identifier associated with an item location. The aisles for one merchant location can be distinct from other merchant locations. As such, items and associated aisles, categories, etc. can be tracked in real-time and utilized to populate or otherwise generate the various data objects of data structure 500. For instance, data structure 500 can be generated by making calls (e.g., via an API) to an existing inventory or point of sale system to access and display or up-to-date information. In some instances, generation of the data structure 500 can be automatically performed by the computing system responsive to obtaining a respective order.

The category 525 can be a type or other designation which can be associated with the various items. For instance, the categories can include things such as produce, beverages, refrigerated items, deli, frozen items, baking, alcohol, bakery, cooking, household supplies, office supplies, candy, or any other designation.

Replacement indication 530 can be associated with acceptable replacement associated with each item. In some instances, the replacement indication 530 can be automatically generated. For instance, absent user input to the contrary, replacement can be set based on data associated with a user profile associated with the order (e.g., user profile associated with Name A 505). If a user profile has historical data indicative of accepting brand B apples as a replacement to brand A apples, then the computing system can automatically indicate that the replacement indication 530 for the brand A apples is brand B apples. Alternatively historical data can be indicative of rejection of all or most replacement recommendations. As such, an item can be automatically flagged to not replace.

Additionally, or alternatively, user input can be obtained as part of an order request (e.g., received from a user device 121) which can explicitly indicate a replacement indication 530. In some instances, a replacement indication 530 can include “none,” “best alternative,” “provide recommended replacement,” one or more specific alternative items, or some other indication. “None” can be associated with providing for no replacement if an item is unavailable. “Best alternative” can allow for a shopper's discretion or use of a replacement recommendation engine for determining a recommended replacement item. “Provide recommended replacement” can allow for shopper's discretion or user of a replacement recommendation engine, however it can require a message to be sent and acknowledged by a user (e.g., via user device 121) to accept the replacement suggestion. One or more specific alternatives can be one or more preselected or pre-approved replacement items, brands, etc. which can automatically replace the initial item with additional explicit approval.

The features associated with the respective data objects are provided for exemplary purposes only and are not meant to be limiting. Additional, or alternative features and associated data can be included or associated with respective data objects and utilized by the computing systems (e.g., network computing system 101) to provide for dynamic order splitting according to example embodiments of the present disclosure.

As described herein, the computing system (e.g., network computing system 101) can dynamically generate and update data structures to facilitate the dynamic adjustment of payload associated with data objects representing orders such that the orders can be fulfilled by users associated with computing devices in a distributed computing system.

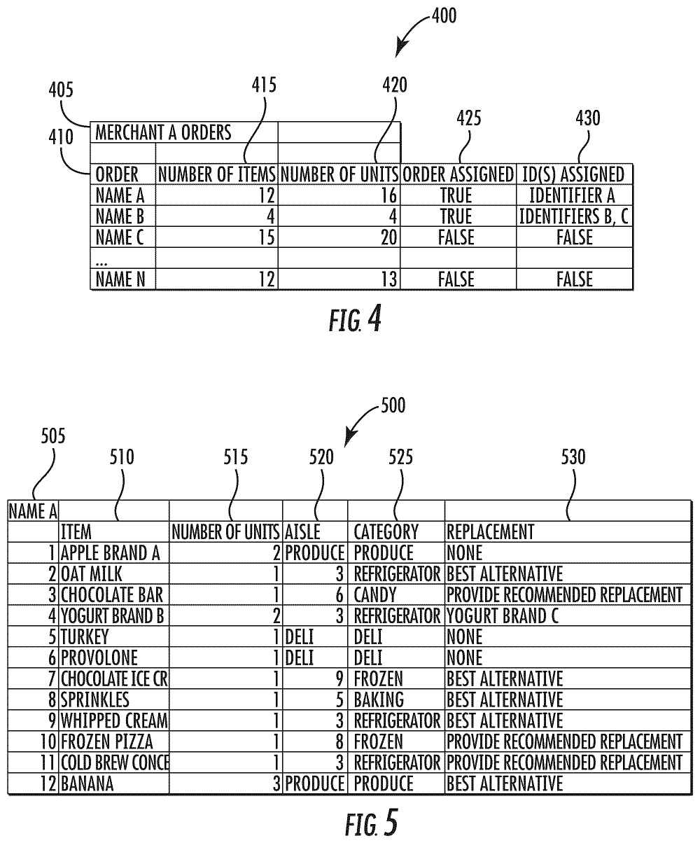

For instance, the computing system can generate a first subset 605 of items and a second subset 635 of items. The distribution of items can be determined based on data indicative of the characteristics of the items and/or data indicative of the characteristics of the available shoppers. For instance, FIG. 6 depicts generating a first subset 605 and a second subset 635 based on the aisle and category of the respective item. For instance, the first subset 605 can include items 610. The items 610 can be associated with a number of units 615 and aisles 620 which can include aisle 3, aisle 5, and aisle 6. The items 610 can be associated with category 625 of refrigerated items, banking, and candy. As can be seen, the replacement indication 630 can be any type of replacement option.

Second subset 635 of items can include items 640. Items 640 can be associated with a number of units 645 and aisles 650. The aisles can include aisle 8, aisle 9, deli, and produce. The items 640 can be associated with category 655 of frozen, deli, and/or produce. As depicts in FIG. 6, the replacement indication 660 can be any type of replacement option.

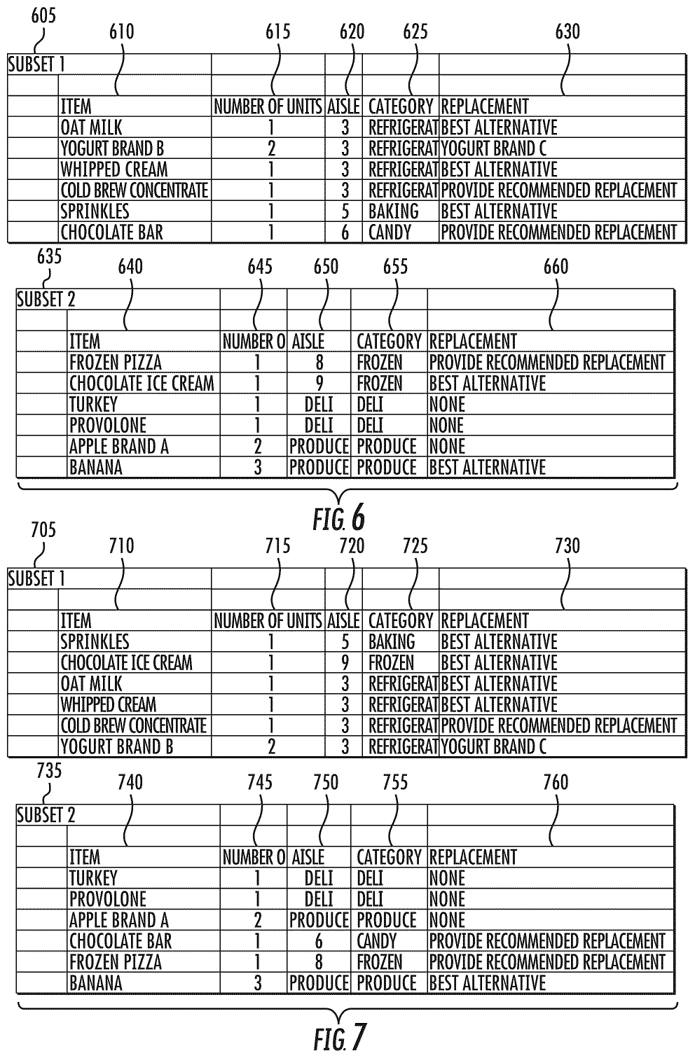

Additionally, or alternatively, the items can be determined, at least based in part on replacement indication 730. For instance, FIG. 7 depicts an example data structure of a memory according to example embodiments of the present disclosure. Example data can include a first subset 705 and a second subset 735. The first subset 705 can include items 710. The items 710 can include, for example, sprinkles, chocolate ice cream, oat milk, whipped cream, cold brew concentrate, and yogurt brand B. Each of the items can be associated with a number of units 715 and an aisle 720. For instance, sprinkles can be associated with aisle 5 and a category 725 of baking. Chocolate ice cream can be associated with aisle 9 and category 725 of frozen. Oat milk, whipped cream, cold brew concentrate, and yogurt brand B can be associated with aisle 3 and a category 725 of refrigerated. Replacement indication 730 for the several of the items can include best alternative, provide recommended replacement, and a specific item (e.g., yogurt brand C).

Second subset 735 of items can be associated with items 740. Items 740 can include, for instance, turkey, provolone, apple brand A, chocolate bar, frozen pizza, and bananas. Each of the items can be associated with a number of units 745 and an aisle 750. Turkey and provolone can be associated with aisle 750 of deli and category 755 of deli. Additionally, in this example, turkey, provolone, and Apple Brand A can be associated with replacement indication of “none” such that the shopper assigned to second subset 735 of items will not need to determine or otherwise locate a replacement item if the items are unavailable. Items 740 chocolate bar and frozen pizza can be associated with “provide recommended replacement” replacement indication. The item 740 banana can include replacement indication of “best alternative”.

Based, at least in part, on the distribution of replacement indication 760, the shoppers for the respective subsets can be selected. For instance, data associated with a found rate or replacement satisfaction or replacement rate for a shopper can be accessed. In some instances, the system can continually generate and update data structures including shopper historical data. For instance, shopper historical data can include shopping rate (e.g., number of items shopped per hour), found rate (percent of items which are located), replacement rate (percent of not-found items for which a replacement if found), and/or replacement satisfaction rate (data obtained from users regarding the substitute items). The system can continually update the information. In some instances, found rate or other metrics can be determined and/or updated after each order performed by a shopper. For instance, the system can log data associated with each order that is fulfilled. In some instances, the metrics can be divided based on aisle, category, replacement indication, or some other feature. Thus, the system can utilize the metrics of various shoppers and item features to individually adjust the allocation of data objects associated with each item to provide for the best utilization of system resources.

Existing methods would adjust or allocate data objects associated with items based solely on category or location within a merchant location. The present application provides for improvements by utilizing newly available data which is stored and updated by the system to allow for personalization and improved allocation of resources based on features of the items as well as features associated with the individual shoppers.

The features associated with the data objects as well as features associated with shoppers can be utilized during the initial distribution of items between the first subset and second subset (or additional subsets) as well as being used for dynamically updating the lists based on real-time data.

For instance, FIG. 8, FIG. 9, and FIG. 10 depict example subsets of items. For instance, FIG. 8 depicts a first subset 805 and a second subset 810. In the example, the items of first subset 805 can be associated with data indicative of the item being shopped. For instance, this can be depicted as a green check 815A-F. Second subset 810 can include a number of items and associated status data. For instance, the status data can include a green check 815A indicated that an item has been shopped, an in progress indication such as indicator 820B, 820D, 820E, and/or 820F, and a not found indicator 820D.

Periodically, the system can determine an order progress status for the respective subsets of items. Based on the order progress status as well as real-time data associated with the shoppers, the system can determine that an item should be removed from a subset and that the data object should be added to a different subset.

For instance, FIG. 9 depicts an example reallocation of an item to a first subset 905 from a second subset 910. For instance, based on the order progress of the first subset 905 including all items being shopped, and second subset 910 including several in progress items, the system can determine that one or more data objects associated with items should be removed 915 from the second subset and added 920 to the first subset.

The system can continue to periodically monitor the order progress status for both of the subsets until the order is completed. For instance, FIG. 10 depicts an example first subset 1005 and second subset 1010 with each item marked with a shopped or unavailable/unfulfilled indication. In some instances, second subset 1010 can include an indication 1015 that an item has been removed. In some instances, first subset 1005 can include a completed indicator 1020 for the item associated with the data object that was representative of the item. The indicator icons used in FIG. 8 to FIG. 10 are meant for illustrative purposes only and can be represented as any form of storable data. In some instances, the stored data can include instructions that when executed cause an interactive user interface of a client device to update and provide the items and/or indicators for display via the interactive user interface.

FIG. 11 depicts example order interfaces for various order statuses according to example embodiments of the present disclosure. Example order interfaces can include claimed order interfaces 1105, 1120, and 1130 and unclaimed order interfaces 1140, 1155, and 1170.

The systems and methods provided herein include example user interface elements which can be used to communicate data indicative of order status. For instance, as depicted in FIG. 11, there can be unclaimed orders associated with interface element 1105, interface element 1120, or interface element 1130. Unclaimed order interface element 1105 can include a selectable component 1115. The selectable component 1115 can be selected via the interactive user interface to select the new and not accepted order. The interface element 1105 can include a number of items/item count 1110A.

Interface element 1120 can be associated with an order that has not been claimed but has an assigned courier. For instance, the courier can have an estimated time until arrival element 1125. The interface element 1120 can include a number of items/item count 1110B.

Interface element 1130 can be associated with an accepted order with no one actively shopping the order. For instance, interface element 1130 can include a finish in element 1135 which indicates an amount of time before the order must be completed. Interface element 1130 can include a number of items/item count 1110C.

Additionally, or alternatively, there can be claimed orders associated with interface element 1140, interface element 1155, or interface element 1170.

For instance, interface element 1140 can be associated with a claimed order where 8 out of 14 items have been shopped. Interface element 1140 can be associated with a finish in element 1150 which indicates an amount of time before the order must be completed. Interface element 1140 can include an indication of number of items left 1145.

Interface element 1155 can be associated with an order that is nearly completed. For instance, the interface element 1155 can include an indication of number of items left 1160. Interface element 1155 can include a finish in element 1165 which indicates an amount of time before the order must be completed. For instance, interface element 1155 can be associated with an order where 11 items have been shopped and four items remain.

Interface element 1170 can be associated with an order that has had all items shopped. Interface element 1170 can include an indication of an estimated time until arrival element 1175 associated with an expected time for a courier to arrive. Interface element 1170 can include a number of items/item count 1110D.

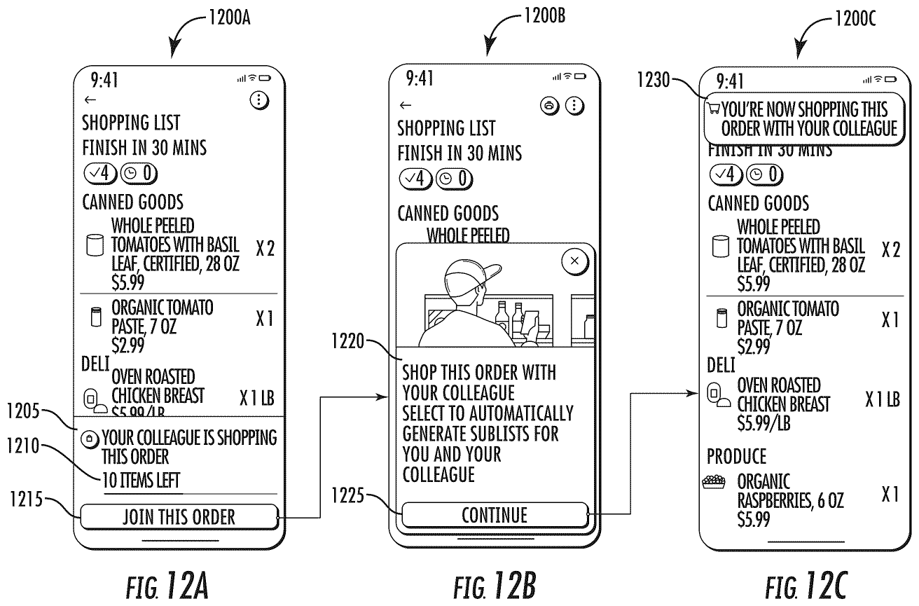

Interface elements depicted in FIG. 11 can be integrated into various interactive graphical user interfaces, such as those depicted in FIG. 12A to FIG. 15D.

FIG. 12A to FIG. 12C depict example interactive graphical user interfaces (GUIs) for a second computing device according to example embodiments of the present disclosure. FIG. 12A depicts an example GUI 1200A which includes a graphical depiction of a shopping list alongside an interactive interface element 1205 associated with initiating the process of determining the order is a split order and generating the subset of data objects associated with items to be distributed across the client devices. Interactive interface element 1215 can include an item left element 1210 which can provide an indication of a number of items left to be shopped. Selectable interface element 1215 can include a selectable interface element 1215. For instance, the selectable interface element 1215 can be configured such that when the computing system obtains data indicative of the selection of selectable interface element 1215, causes example GUI 1200A to update to example GUI 1200B.

Example GUI 1200B can include interface element 1220 which can provide an additional visual indication and message associated with the split order. Interface element 1220 can include a selectable interface element 1225, which can be configured such that when the computing system obtains data indicative of a selection of selectable interface element 1225, causes example GUI 1200B to update to example GUI 1200C.

Example GUI 1200C can include interface element 1230. Interface element 1230 can include an indication that the order is now split and that items have been broken into subsets and distributed across the client devices associated with the respective shoppers or shopper profiles.

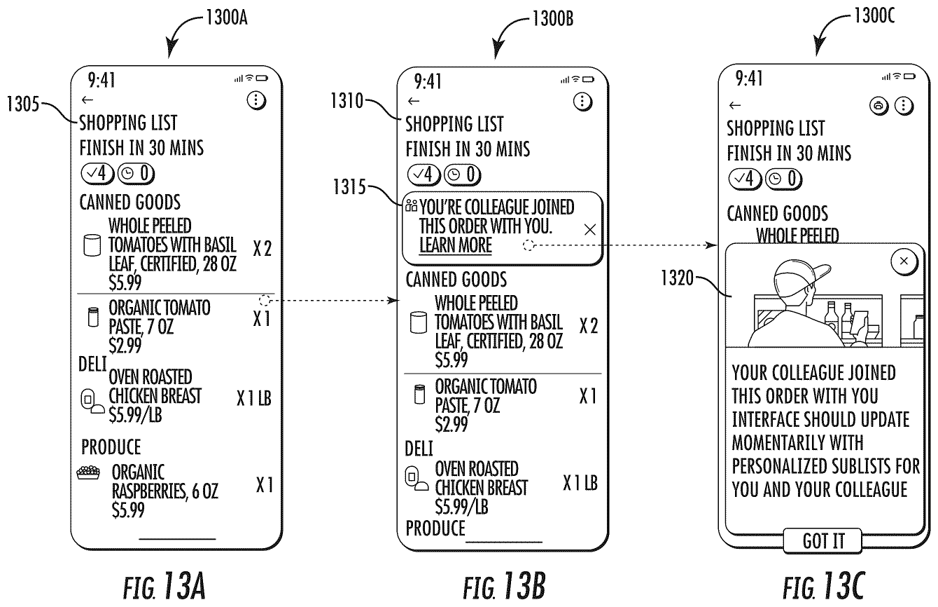

FIG. 13A to FIG. 13C depict example interactive GUIs for a first computing device according to example embodiments of the present disclosure. Example GUIs can include example GUI 1300A. Example GUI 1300A can include an initial shopping interface including a shopping list 1305 for an order which has been claimed and begun to shop. Responsive to the selection of an interface element on a second, separate client device, for a second user to join the shopping list 1305. Responsive to the second client device indicating joining of the shopping list, example GUI 1300A can update to example GUI 1300B.

As depicted in FIG. 13B, GUI 1300B can include a shopping list 1310 and a message element 1315 which can include a message relating to splitting the order. For instance, message element 1315 can include language such as, “your colleague joined this order with you. Learn more.” A portion of message element 1315 can be selected, and responsive to the selection, example GUI 1300B can update to example GUI 1300C.

As depicted in FIG. 13C, example GUI 1300C can include a message element 1320 which can include a message providing additional context or details relating to a colleague joining the order as well as instructions regarding the system automatically determining the subsets of items and distributing the payload associated with the respective data objects. In some instances, message element 1320 can additionally, or alternatively, include a selectable user interface element which can be selected to return to the main user interface (e.g., as depicted in FIG. 13A).

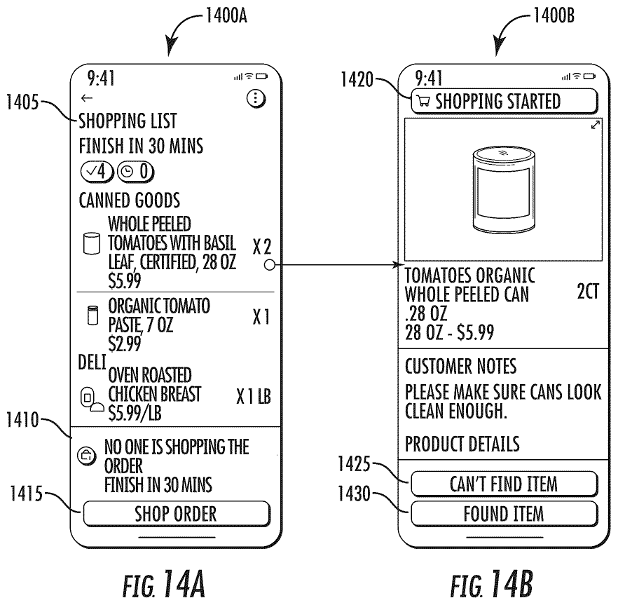

FIG. 14A to FIG. 14B depicts example interactive GUIs of a first device for interacting with an unclaimed order according to example embodiments of the present disclosure. For instance, FIG. 14A depicts example GUI 1400A. Example GUI 1400A can include a shopping list 1405 and an interactive interface element 1410. Interactive input element 1400 can include an indication about the order status (e.g., noting that the order is not claimed and that “no one is shopping the order.” Interactive interface element 1410 can include selectable interface element 1415. Upon selection of interactive interface element 1415, example GUI 1400A can be updated to example GUI 1400B. Example GUI 1400B can include message indication element 1420 stating that “shopping has started.” Example GUI 1400B can include selectable user interface element 1425 for “cannot find order” and/or selectable user interface element 1430 for “found item.”

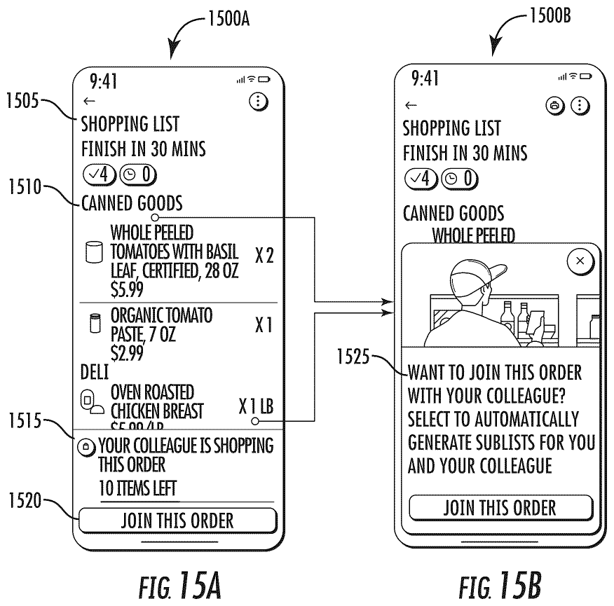

FIG. 15A to FIG. 15B depict example interactive GUIs of a second device for interacting with a claimed order according to example embodiments of the present disclosure. For instance, FIG. 15A depicts example GUI 1500A. Example GUI 1500A can include shopping list 1505, individual items 1510, interactive input element 1515, and selectable interface element 1520. For instance, shopping list 1505 can include a plurality of individual items 1510 with associated descriptions, quantities, or instructions for locating. Interactive input element 1515 can include an indication about the order status. For instance, the order status can note that the order is claimed and that “Your colleague is shopping this order” and indication of the number of items left. Interactive input element 1515 can include selectable interface element 1520. Upon selection of selectable interface element 1520, example GUI 1500A can update to example GUI 1500B. Example GUI 1500B can include an interactive user interface element 1525 which provides a message that selection of the join this order button will result in the remaining items of the shopping list being automatically allocated into subsets made up of data objects which will be distributed across the devices.

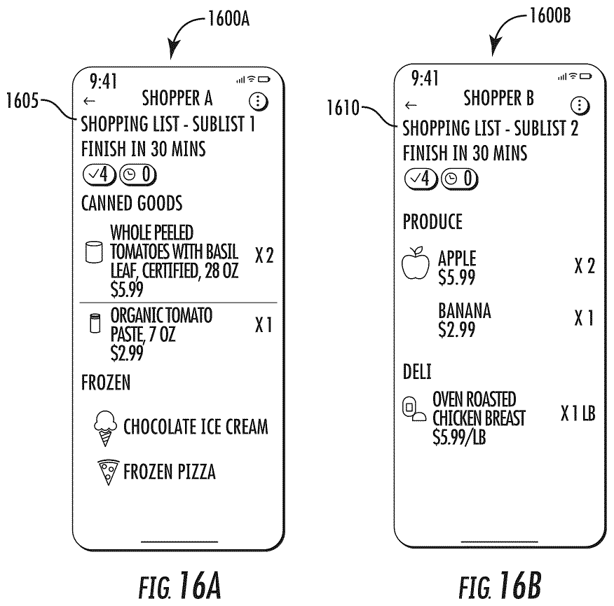

FIG. 16A includes an updated example GUI 1600A which includes a first subset 1605 of items for the shopper associated with the first user device to fulfill. FIG. 16B depicts an updated example GUI 1600B which includes a second subset 1610 of items for the shopper associated with the second user device to fulfill. As discussed herein, the initial split can be performed responsive to a second user selecting an already claimed shopping list. Additionally, or alternatively, the system can encourage selection of the shopping list by a second shopper. This can include providing messages to a second device to suggest that the second shopper claim the order/shopping list (e.g., a portion thereof).

In some instances, the system can continually monitor the progress of the respective shoppers (e.g., via the continually updated data structures) to determine that items should be removed or added to respective subsets associated with shoppers. The system can automatically adjust and provide updated GUIs including notifications highlighting the items which have been removed or added (E.g., as depicted in FIG. 8 to FIG. 10.

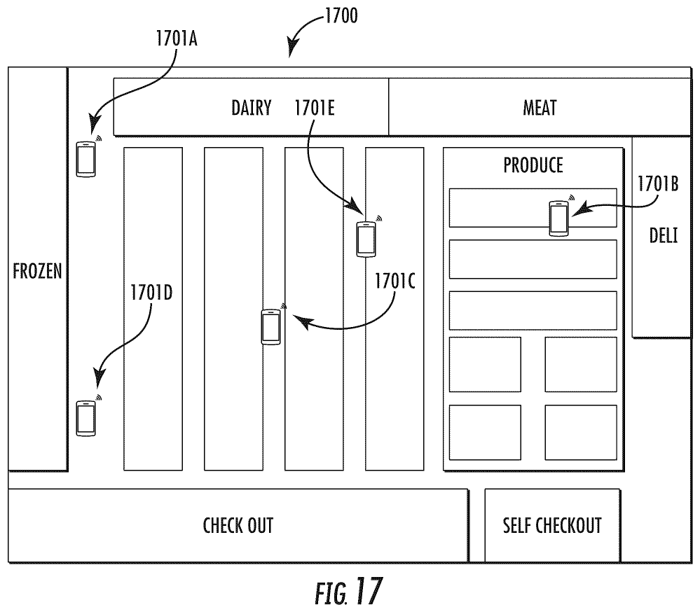

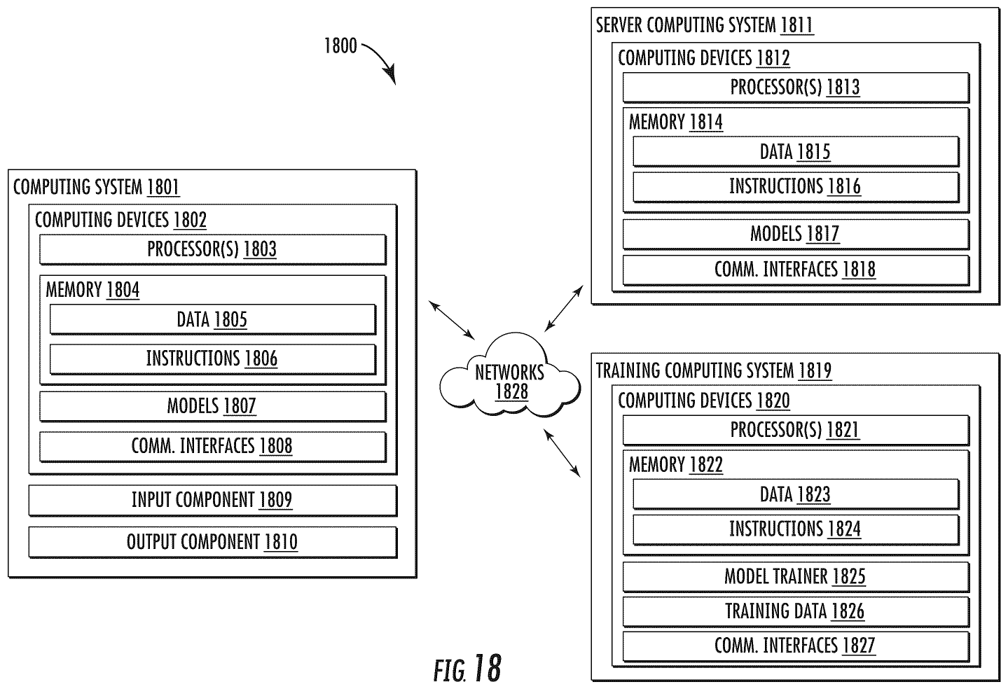

FIG. 17 depicts an example merchant location 1700 including a number of shopper client devices 1701A-E. For instance, the various client device locations. In some instances, a shopper to be paired as a second shopper can be based at least in part on the remaining items, the remaining item's locations within the store, and the shopper device location. For instance, if shopper device 1701A is shopping a first order which has several not-yet-shopped deli or produce items, the shopper associated with shopper device 1701B can be provided a real-time message (e.g., push notification) with an offer to join or otherwise split the order with the shopper associated with shopper device 1701A.

In some instances, the computing system can select a shopper device of a number of shopper devices to provide a real-time message (e.g., push notification). For instance, the computing system can determine a plurality of shopper devices are active. In some instances, shopper devices can be associated with a logged-in or otherwise associated with a shopper profile. Shopper profile can include performance metric data. For instance, shopper profile performance metric data can include a shopper rating, shopper performance on categories of items (e.g., produce selection, replacement selection), or other shopper metrics. In some instances, computing system can determine near real-time location of the shopper device. The computing system can access shopper profile data or current location (e.g., near real-time location) data associated with the shopper device. In some examples, the shopper profile data and/or current location data can be utilized to select the shopper device for receipt of the real-time message. Additionally, or alternatively, the shopper profile data or current location data can be utilized to determine how to allocate items and the associated data objects across the distributed computing system.

For instance, the number of shoppers and active shopper devices can include five shopper devices. A first shopper device can be associated with a user with a high satisfaction rating for produce. A second shopper device can be associated with an average satisfaction rate for produce. As such, an example implementation can include transmitting an offer for splitting an item including produce with the first shopper advise. Additionally, or alternatively, an example implementation can include generating the subset of items for the first shopper to include data objects representative of produce items such that the first shopper with a higher produce item rating can fulfill that portion of the distributed data objects representative of items of the order.

Additionally, or alternatively, as described herein, shopper A can indicate that a replacement item is needed. The replacement item can be located near shopper device 1701E. As such, the system can transmit a real-time message (e.g., push notification) to shopper device 1701E indicating an offer to join or otherwise split the order with the shopper associated with shopper device 1701A.

FIG. 18 depicts a block diagram of an example computing system 1800 for implementing systems and methods according to example embodiments of the present disclosure. The computing system 1800 includes a computing system 1801 (e.g., a shopper device 131 corresponding to a shopper 135), a server computing system 1811 (e.g., a network computing system 101, cloud computing platform), and a training computing system 1819 communicatively coupled over one or more networks 1828.

The computing system 1801 can include one or more computing devices 1802 or circuitry. For instance, the computing system 1801 can include a control circuit 1803 and a non-transitory computer-readable medium 1804, also referred to herein as memory. In an embodiment, the control circuit 1803 can include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 1803 can be programmed by one or more computer-readable or computer-executable instructions stored on the non-transitory computer-readable medium 1804.

In an embodiment, the non-transitory computer-readable medium 1804 can be a memory device, also referred to as a data storage device, which can include an electronic storage device, a magnetic storage device, an optical storage device, an electromagnetic storage device, a semiconductor storage device, or any suitable combination thereof. The non-transitory computer-readable medium 1804 can form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 1804 can store information that can be accessed by the control circuit 1803. For instance, the non-transitory computer-readable medium 1804 (e.g., memory devices) can store data 1805 that can be obtained, received, accessed, written, manipulated, created, and/or stored. The data 1805 can include, for instance, any of the data or information described herein. In some implementations, the computing system 1801 can obtain data from one or more memories that are remote from the computing system 1801.

The non-transitory computer-readable medium 1804 can also store computer-readable instructions 1806 that can be executed by the control circuit 1803. The instructions 1806 can be software written in any suitable programming language or can be implemented in hardware.

The instructions 1806 can be executed in logically and/or virtually separate threads on the control circuit 1803. For example, the non-transitory computer-readable medium 1804 can store instructions 1806 that when executed by the control circuit 1803 cause the control circuit 1803 to perform any of the operations, methods and/or processes described herein. In some cases, the non-transitory computer-readable medium 1804 can store computer-executable instructions or computer-readable instructions, such as instructions to perform at least a portion of the method of FIG. 3.

In an embodiment, the computing system 1801 can store or include one or more machine-learned models 1807. For example, the machine-learned models 1807 can be or can otherwise include various machine-learned models. In an embodiment, the machine-learned models 1807 can include neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In an embodiment, the one or more machine-learned models 1807 can be received from the server computing system 1811 over networks 1828, stored in the computing system 1801 (e.g., non-transitory computer-readable medium 1804), and then used or otherwise implemented by the control circuit 1803. In an embodiment, the computing system 1801 can implement multiple parallel instances of a single model.

Additionally, or alternatively, one or more machine-learned models 1807 can be included in or otherwise stored and implemented by the server computing system 1811 that communicates with the computing system 1801 according to a client-server relationship. For example, the machine-learned models 1807 can be implemented by the server computing system 1811 as a portion of a web service. Thus, one or more models 1807 can be stored and implemented at the computing system 1801 and/or one or more models 1807 can be stored and implemented at the server computing system 1811.

The computing system 1801 can include one or more communication interfaces 1808. The communication interfaces 1808 can be used to communicate with one or more other systems. The communication interfaces 1808 can include any circuits, components, software, etc. for communicating via one or more networks (e.g., networks 1828). In some implementations, the communication interfaces 1808 can include for example, one or more of a communications controller, receiver, transceiver, transmitter, port, conductors, software and/or hardware for communicating data/information.

The computing system 1801 can also include one or more user input components 1809 that receives user input. For example, the user input component 1809 can be a touch-sensitive component (e.g., a touch-sensitive user interface of a client device) that is sensitive to the touch of a user input object (e.g., a finger or a stylus). The touch-sensitive component can serve to implement a virtual keyboard. Other example user input components include a microphone, a traditional keyboard, cursor-device, joystick, or other devices by which a user can provide user input.

The computing system 1801 can include one or more output components 1810. The output components 1810 can include hardware and/or software for audibly or visually producing content. For instance, the output components 1810 can include one or more speakers, earpieces, headsets, handsets, etc. The output components 1810 can include a display device, which can include hardware for displaying a user interface and/or messages for a user. By way of example, the output component 1810 can include a display screen, CRT, LCD, plasma screen, touch screen, TV, projector, tablet, and/or other suitable display components.

The server computing system 1811 can include one or more computing devices 1812. In an embodiment, the server computing system 1811 can include or is otherwise implemented by one or more server computing devices. In instances in which the server computing system 1811 includes plural server computing devices, such server computing devices can operate according to sequential computing architectures, parallel computing architectures, or some combination thereof.

The server computing system 1811 can include a control circuit 1813 and a non-transitory computer-readable medium 1814, also referred to herein as memory 1814. In an embodiment, the control circuit 1813 can include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 1813 can be programmed by one or more computer-readable or computer-executable instructions stored on the non-transitory computer-readable medium 1814.

In an embodiment, the non-transitory computer-readable medium 1814 can be a memory device, also referred to as a data storage device, which can include an electronic storage device, a magnetic storage device, an optical storage device, an electromagnetic storage device, a semiconductor storage device, or any suitable combination thereof. The non-transitory computer-readable medium can form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 1814 can store information that can be accessed by the control circuit 1813. For instance, the non-transitory computer-readable medium 1814 (e.g., memory devices) can store data 1815 that can be obtained, received, accessed, written, manipulated, created, and/or stored. The data 1815 can include, for instance, any of the data or information described herein. In some implementations, the server computing system 1811 can obtain data from one or more memories that are remote from the server computing system 1811.

The non-transitory computer-readable medium 1814 can also store computer-readable instructions 1816 that can be executed by the control circuit 1813. The instructions 1816 can be software written in any suitable programming language or can be implemented in hardware. The instructions can include computer-readable instructions, computer-executable instructions, etc.

The instructions 1816 can be executed in logically and/or virtually separate threads on the control circuit 1813. For example, the non-transitory computer-readable medium 1814 can store instructions 1816 that when executed by the control circuit 1813 cause the control circuit 1813 to perform any of the operations, methods and/or processes described herein. In some cases, the non-transitory computer-readable medium 1814 can store computer-executable instructions or computer-readable instructions, such as instructions to perform at least a portion of the methods of FIG. 9.

The server computing system 1811 can store or otherwise include one or more machine-learned models 1817. The machine-learned models 1817 can include or be the same as the models 1807 stored in computing system 1801. In an embodiment, the machine-learned models 1817 can include an unsupervised learning model. In an embodiment, the machine-learned models 1817 can include neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

The machine-learned models described in this specification can have various types of input data and/or combinations thereof, representing data available to sensors and/or other systems onboard a vehicle. Input data can include, for example, latent encoding data (e.g., a latent space representation of an input, etc.), statistical data (e.g., data computed and/or calculated from some other data source), sensor data (e.g., raw and/or processed data captured by a sensor of the vehicle), or other types of data.

The server computing system 1811 can include one or more communication interfaces 1818. The communication interfaces 1818 can be used to communicate with one or more other systems. The communication interfaces 1818 can include any circuits, components, software, etc. for communicating via one or more networks (e.g., networks 1828). In some implementations, the communication interfaces 1818 can include for example, one or more of a communications controller, receiver, transceiver, transmitter, port, conductors, software and/or hardware for communicating data/information.

The computing system 1801 and/or the server computing system 1811 can train the models 1807 and 1817 via interaction with the training computing system 1819 that is communicatively coupled over the networks 1828. The training computing system 1819 can be separate from the server computing system 1811 or can be a portion of the server computing system 1811.

The training computing system 1819 can include one or more computing devices 1820. In an embodiment, the training computing system 1819 can include or is otherwise implemented by one or more server computing devices. In instances in which the training computing system 1819 includes plural server computing devices, such server computing devices can operate according to sequential computing architectures, parallel computing architectures, or some combination thereof.

The training computing system 1819 can include a control circuit 1821 and a non-transitory computer-readable medium 1822, also referred to herein as memory 1822. In an embodiment, the control circuit 1821 can include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 1821 can be programmed by one or more computer-readable or computer-executable instructions stored on the non-transitory computer-readable medium 1822.

In an embodiment, the non-transitory computer-readable medium 1822 can be a memory device, also referred to as a data storage device, which can include an electronic storage device, a magnetic storage device, an optical storage device, an electromagnetic storage device, a semiconductor storage device, or any suitable combination thereof. The non-transitory computer-readable medium can form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 1822 can store information that can be accessed by the control circuit 1821. For instance, the non-transitory computer-readable medium 1822 (e.g., memory devices) can store data 1823 that can be obtained, received, accessed, written, manipulated, created, and/or stored. The data 1823 can include, for instance, any of the data or information described herein. In some implementations, the training computing system 1819 can obtain data from one or more memories that are remote from the training computing system 1819.

The non-transitory computer-readable medium 1822 can also store computer-readable instructions 1824 that can be executed by the control circuit 1821. The instructions 1824 can be software written in any suitable programming language or can be implemented in hardware. The instructions can include computer-readable instructions, computer-executable instructions, etc.

The instructions 1824 can be executed in logically or virtually separate threads on the control circuit 1821. For example, the non-transitory computer-readable medium 1822 can store instructions 1824 that when executed by the control circuit 1821 cause the control circuit 1821 to perform any of the operations, methods and/or processes described herein. In some cases, the non-transitory computer-readable medium 1822 can store computer-executable instructions or computer-readable instructions, such as instructions to perform at least a portion of the methods of FIG. 9.

The training computing system 1819 can include a model trainer 1825 that trains the machine-learned models 1807, 1817 stored at the computing system 1801 and/or the server computing system 1811 using various training or learning techniques. For example, the models 1807, 1817 can be trained using a loss function. By way of example, for training a machine-learned segmentation or recommendation model, the model trainer 1825 can use a loss function. For example, a loss function can be backpropagated through the model(s) 1807, 1817 to update one or more parameters of the model(s) 1807, 1817 (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

The model trainer 1825 can train the models 1807, 1817 (e.g., a machine-learned clustering model) in an unsupervised fashion. As such, the models 1807, 1817 can be effectively trained using unlabeled data for particular applications or problem domains, which improves performance and adaptability of the models 1807, 1817.

The training computing system 1819 can modify parameters of the models 1807, 1817 (e.g., the machine-learned models 114, 120, 130, 150) based on the loss function such that the models 1807, 1817 can be effectively trained for specific applications in an unsupervised manner without labeled data.

The model trainer 1825 can utilize training techniques, such as backwards propagation of errors. For example, a loss function can be backpropagated through a model to update one or more parameters of the models (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In an embodiment, performing backwards propagation of errors can include performing truncated backpropagation through time. The model trainer 1825 can perform a number of generalization techniques (e.g., weight decays, dropouts, etc.) to improve the generalization capability of a model being trained. In particular, the model trainer 1825 can train the machine-learned models 1807, 1817 based on a set of training data 1826.

The training data 1826 can include unlabeled training data for training in an unsupervised fashion. In an example, the training data 1826 can include unlabeled sets of data indicative of varying degrees of ripeness for produce grocery items and data indicative of confirmed ripeness (e.g., unripe, ripe, over ripe), for a produce grocery items. The training data 1826 can be specific to a grocery item to help focus the models 1807, 1817 on the particular grocery item.

In an embodiment, training examples can be provided by the computing system 1801 (e.g., client device of the shopper). Thus, in such implementations, a model 1807 provided to the computing system 1801 can be trained by the training computing system 1819 in a manner to personalize the model 1807.

The model trainer 1825 can include computer logic utilized to provide desired functionality. The model trainer 1825 can be implemented in hardware, firmware, and/or software controlling a general-purpose processor. For example, in an embodiment, the model trainer 1825 can include program files stored on a storage device, loaded into a memory and executed by one or more processors. In other implementations, the model trainer 1825 can include one or more sets of computer-executable instructions that are stored in a tangible computer-readable storage medium such as RAM, hard disk, or optical or magnetic media.

The training computing system 1819 can include one or more communication interfaces 1827. The communication interfaces 1827 can be used to communicate with one or more other systems. The communication interfaces 1827 can include any circuits, components, software, etc. for communicating via one or more networks (e.g., networks 1828). In some implementations, the communication interfaces 1827 can include for example, one or more of a communications controller, receiver, transceiver, transmitter, port, conductors, software and/or hardware for communicating data/information.

The one or more networks 1828 can be any type of communications network, such as a local area network (e.g., intranet), wide area network (e.g., Internet), or some combination thereof and can include any number of wired or wireless links. In general, communication over a network 1828 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 18 illustrates one example computing system that can be used to implement the present disclosure. Other computing systems can be used as well. For example, in an embodiment, the computing system 1801 can include the model trainer 1825 and the training data 1826. In such implementations, the models 1807, 1817 can be both trained and used locally at the computing system 1801. In some of such implementations, the computing system 1801 can implement the model trainer 1825 to personalize the models 1807, 1817.

Computing tasks discussed herein as being performed at certain computing device(s)/systems can instead be performed at another computing device/system, or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks or operations can be performed sequentially or in parallel. Data and instructions can be stored in a single memory device or across multiple memory devices.

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

Aspects of the disclosure have been described in terms of illustrative implementations thereof. Numerous other implementations, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. The term “or” and “and/or” can be used interchangeably herein. Lists joined by a particular conjunction such as “or,” for example, can refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims discussed herein can be adapted, rearranged, expanded, omitted, combined, or modified in various ways without deviating from the scope of the present disclosure. Some implementations are described with a reference numeral, for example illustrated purposes and are not meant to be limiting.

What is claimed is:

1. A computer-implemented method, including:
accessing data comprising a centralized data structure comprising a plurality of order requests, wherein each order request of a centralized list of order requests comprises a plurality of data objects, each data object being indicative of an item;
computing, based on a first order request of the centralized list of order requests and merchant location data, a shopping list comprising: (i) the plurality of data objects for items to be retrieved for the first order and (ii) characteristic data for each respective item;
storing the computed shopping list and a plurality of other additional shopping lists in a shopping list data store, the shopping list data store accessible to a plurality of shopper computing devices;
accessing data indicative of selection of the first shopping list by a first computing device of the plurality of shopper computing devices;
automatically updating, based on accessing the data indicative of the selection of the first shopping list, the shopping list data store to include order status data;
accessing data indicative of selection of the first shopping list by a second computing device of the plurality of shopper computing devices;
based on accessing data indicative of selection of the first shopping list by the first computing device and the second computing device, computing a first subset of items for the first computing device and a second subset of items for the second computing device based on (i) features associated with the first computing device, (ii) features associated with the second computing device, and (iii) the characteristic data of each respective item of a plurality of items; and
transmitting data comprising instructions, that, when executed by the first computing device, cause an interactive user interface of the first computing device to provide the first subset of items for display via the interactive user interface of the first computing device.

2. The computer-implemented method of claim 1, comprising:
transmitting data comprising instructions, that, when executed by the second computing device, cause the interactive user interface of the second computing device to provide the second subset of items for display via the interactive user interface of the second computing device.

3. The computer-implemented method of claim 2, comprising:
computing a first progress metric for the first computing device and a second progress metric for the second computing device, the first progress metric indicative of an amount of completion of the first subset of the first shopping list and the second progress metric indicative of an amount of completion of the second subset of the first shopping list; and
based on the first progress metric and the second progress metric, periodically transmitting instructions, that when executed, cause at least one of: (i) the interactive user interface of the first computing device or (ii) the interactive user interface of the second computing device to be updated.

4. The computer-implemented method of claim 3, wherein periodically transmitting instructions, that when executed, cause the interactive user interface of the first computing device and the interactive user interface of the second computing device to be updated comprises:
accessing current location data indicative of a real-time location of the first computing device and a real-time location of the second computing device within the merchant location;
based on (i) the current location data, (ii) the first progress metric, and (iii) the second progress metric, dynamically adjusting a distribution of items between the first subset of items and the second subset of items; and
based on dynamically adjusting the distribution of items, automatically transmitting instructions which cause the interactive user interface associated with the first computing device to provide for display an updated first subset of items and the interactive user interface associated with the second computing system to provide for display an updated second subset of items.

5. The computer-implemented method of claim 4, wherein dynamically adjusting the distribution of items between the first subset of items and the second subset of items comprises removing one or more items from the first subset of items and adding the one or more removed items to the second subset of items.

6. The computer-implemented method of claim 4, the method comprising:
determining a replacement item is needed for a first item of the first subset of items;
based on a location of a recommended replacement item and the current location data, updating the second subset of items to include the replacement item; and
transmitting data comprising instructions that, when executed by the second computing device, cause the interactive user interface of the second computing device to provide the updated second subset of items for display via the interactive user interface of the second computing device.

7. The computer-implemented method of claim 6, wherein the location of the recommended replacement item and the real-time location of the second computing device are within a predefined threshold.

8. The computer-implemented method of claim 1, wherein computing the first subset of items for the first computing device and the second subset of items for the second computing device comprising:
determining a percent completion of the first shopping list; and
based on the percent completion of the first shopping list exceeding a predefined range, updating the order status data to indicate that the order cannot be selected by a second computing device.

9. The computer-implemented method of claim 1, wherein the features associated with the first computing device and the features associated with the second computing device comprise historical performance of an operator associated with the respective device or experience level of the operator associated with the respective device.

10. The computer-implemented method of claim 9, wherein the historical performance of the operator comprises an aggregation of metrics associated with past order fulfillment instance, the metrics comprising at least one of: (i) an order replacement satisfaction rate, (ii) a shop time, or (ii) a wait time for a courier picking up the order.

11. The computer-implemented method of claim 9, wherein the experience level of the operator is determined based on at least one of: (i) a number of previously completed orders or (ii) characteristics of previously completed orders.

12. A computing system
one or more processors; and
one or more non-transitory, computer-readable media storing instructions that are executable by the one or more processors to cause the computing system to perform operations, the operations comprising:
accessing data comprising a centralized data structure comprising a plurality of order requests, wherein each order request of a centralized list of order requests comprises a plurality of data objects, each data object being indicative of an item;
computing, based on a first order request of the centralized list of order requests and merchant location data, a shopping list comprising: (i) the plurality of data objects for items to be retrieved for the first order and (ii) characteristic data for each respective item;
storing the computed shopping list and a plurality of other additional shopping lists in a shopping list data store, the shopping list data store accessible to a plurality of shopper computing devices;
accessing data indicative of selection of the first shopping list by a first computing device of the plurality of shopper computing devices;
automatically updating, based on accessing the data indicative of the selection of the first shopping list, the shopping list data store to include order status data;
accessing data indicative of selection of the first shopping list by a second computing device of the plurality of shopper computing devices;
based on accessing data indicative of selection of the first shopping list by the first computing device and the second computing device, computing a first subset of items for the first computing device and a second subset of items for the second computing device based on (i) features associated with the first computing device, (ii) features associated with the second computing device, and (iii) the characteristic data of each respective data object of the plurality of data objects for items; and
transmitting data comprising instructions, that, when executed by the first computing device, cause an interactive user interface of the first computing device to provide the first subset of items for display via the interactive user interface of the first computing device.

13. The computing system of claim 12, wherein the characteristic data of each respective data object of the plurality of data objects for items comprises at least one of: (i) an item type, (ii) an item location, or (iii) an item category.

14. The computing system of claim 13, wherein the item type comprises at least one of: (i) frozen, (ii) perishable, (iii) non-perishable, (iv) non-edible, (v) refrigerated, or (vi) shelf stable.

15. The computing system of claim 13, wherein the item category comprises an indication of at least one of: (i) produce, (ii) canned goods, (iii) outside aisle, (iv) pharmacy, (v) bakery, (vi) snacks, (vii) beverages, or (viii) frozen goods.

16. The computing system of claim 12, wherein computing first subset of items and the second subset of items is performed responsive to accessing data indicative of the first computing device indicating a need for assistance.

17. The computing system of claim 12, wherein the order status comprises unclaimed, claimed and not begun, in progress, nearly done, or completed.

18. The computing system of claim 12, wherein computing the first subset of items and the second subset of items is performed responsive to determining that a courier associated with picking up the first shopping list will arrive before the first computing device completes the shopping list.

19. The computing system of claim 12, comprising:
based on obtaining a request for the computed shopping list and the plurality of other additional shopping lists, transmitting data comprising instructions, that, when executed by a shopper computing device, cause presentation of the shopping list and the plurality of other additional shopping lists via an interactive user interface the shopper computing device.

20. One or more non-transitory computer readable media storing instructions that are executable by one or more processors to perform operations, comprising:
accessing data comprising a centralized data structure comprising a plurality of order requests, wherein each order request of the centralized data structure of order requests comprises a plurality of data objects, each data object being indicative of an item;
computing, based on a first order request of the centralized data structure of order requests and merchant location data, a shopping list comprising: (i) the plurality of data objects for items to be retrieved for the first order and (ii) characteristic data for each respective item;
storing the computed shopping list and a plurality of other additional shopping lists in a shopping list data store, the shopping list data store accessible to a plurality of shopper computing devices;
accessing data indicative of selection of the first shopping list by a first computing device of the plurality of shopper computing devices;
automatically updating, based on accessing the data indicative of the selection of the first shopping list, the shopping list data store to include order status data;
accessing data indicative of selection of the first shopping list by a second computing device of the plurality of shopper computing devices;
based on accessing data indicative of selection of the first shopping list by the first computing device and the second computing device, computing a first subset of items for the first computing device and a second subset of items for the second computing device based on (i) features associated with the first computing device, (ii) features associated with the second computing device, and (iii) the characteristic data of each respective data object of the plurality of data objects for items; and
transmitting data comprising instructions, that, when executed by the first computing device, cause an interactive user interface of the first computing device to provide the first subset of items for display via the interactive user interface of the first computing device.
